(19) United States
(12) Patent Application Publication
(10) Pub. No.: US 2023/0180730 A1
(43) Pub. Date: Jun. 15, 2023

(54) SENSING ALARM UNIT FOR ROTATING SPOOL OR REEL EQUIPPED FISHING APPARATUS

(71) Applicant: Vulture Systems, LLC, Stoughton, WI (US)

(72) Inventors: Gregg J. Haensgen, Menomonee Falls, WI (US); James Milota, Stoughton, WI (US); Richard Lucas, Zimmerman, MN (US); Bradley Brunker, Mazomanie, WI (US); Cooper Haensgen, Menomonee Falls, WI (US)

(21) Appl. No.: 17/980,550

(22) Filed: Nov. 4, 2022

Related U.S. Application Data
(60) Provisional application No. 63/275,038, filed on Nov. 3, 2021.

(51) Int. Cl. A01K 89/015; G01D 5/16; A01K 97/12

(52) U.S. Cl. CPC A01K 89/0178; G01D 5/16; A01K 97/125

(57) ABSTRACT

An alarm system for a fishing apparatus that is an ice fishing tip-up employing a sensor alarm unit with a housing, processor, sensor, power source, and onboard wireless communications, the unit mountable to one of a base and fish strike indicating flagpole of the tip-up with the sensor configured to sense a magnet on the tip-up during operation and cause the processor to alarm when a fish strikes. The unit has a mounting arrangement with a clamp releasably attaching the unit to the flagpole for movement in unison therewith from an armed position towards a fish strike indicating position. The mounting arrangement includes a twist-lock dovetail joint used to removably mount the unit to the tip-up base. The dovetail joint removably attaches the housing to a unit base mounted to the tip-up base. The unit can have another sensor that senses motion, orientation, angle, rotation of the unit.

### CROSS-REFERENCE

This application claims priority in and the benefit of U.S. Provisional Patent Application No. 63/275,038 filed Nov. 3, 2021, the entire disclosure of which also is hereby expressly incorporated herein by reference.

### FIELD OF THE INVENTION

The present invention is directed to a fishing equipment alarm system and more particularly to a sensing alarm unit well suited for outdoor use with a fishing apparatus that preferably is an ice fishing tip up and other types of fishing apparatuses, such as fishing reels, which is equipped with at least one onboard magnetic field sensor configured to detect a fish strike by way of detecting rotation of one or more components of the fishing apparatus when a fish strikes.

### BACKGROUND OF THE INVENTION

In the past, there have been many attempts at making sensing units for sensing a fish strike whether the sensing unit be configured for use with a fishing apparatus, such as an ice fishing tip up, a rod and reel, other types of fishing reels, and/or with other types of fishing equipment. One problem is that it can be very difficult to detect accurately when a fish strikes the bait attached to fishing line extending from a spool of a rotary reel of a fishing apparatus such that while many attempts have been made, nearly all have been fraught with difficulties and/or drawbacks. In particular, it can be challenging to accurately detect an amount or rate of rotation and/or number of rotations of such a spool or reel of a fishing apparatus that is indicative of not only a fish strike occurring but which avoids false positives, particularly occurrences which appear to be a fish strike that would ordinarily trigger a fish strike alarm but which are not fish strikes.

What is needed is a sensing alarm system which is or includes a sensing unit configured for sensing rotation of one or more components of a fishing apparatus during fishing operation indicative of a fish strike that is accurate and can discriminate against rotation indicative of a fish strike but which is not.

### SUMMARY OF THE INVENTION

The present invention is directed to an inventive alarm system including a base having an opening contained therein, an upright having a top and bottom extending through the opening, a crossbar extending from the upright adjacent to the top, a spool located adjacent to the bottom, and a sensor unit housing having at least one dovetail holder mounting mechanism. The sensor unit housing contains a power source, at least one sensor, and a processor. The sensor unit housing is movable between a first configuration and a second configuration. In the first configuration, the at least one dovetail holder mounting mechanism is secured by at least one releasable clamp to a flag pole with the clamp clamping on the flagpole. In another configuration, the at least one dovetail holder mounting mechanism is secured to the base. Regardless of the configuration, an alarm is distributed from the sensor unit housing when rotation of the spool occurs.

In the another configuration, at least one magnet is associated with one or more of the upright and the crossbar. The at least one sensor contained within the sensor unit housing detects rotation of the crossbar based on magnetic signals from the at least one magnet. The at least one sensor can detect the number of rotations, as well as the speed or rotations of the crossbar. The sensor unit housing can also include at least one LED light, where the at least one LED light flashes different light sequences based on the number of rotations and speed of rotations, allowing a user to understand the number and speed of rotations from afar. Also, the sensor unit housing can transmit a signal wirelessly to a master controller also located afar from the sensor unit housing.

Additionally, a magnet can be associated with the base. In the first configuration, the at least one sensor can detect the presence of the magnet when the flag pole is located in an armed position where the flag pull is partially or substantially parallel with the base. In the armed position, the sensor unit housing can still be vertically displaced from the magnet, preventing the sensor unit housing from potentially freezing to the magnet. When the flag pull is released by the crossbar, the flag pole moves upwardly to a disarmed position, and the at least one sensor detects the lack of the magnet. The sensor unit housing then notifies a user that the flag pole is in the disarmed position. Alternatively, the at least one sensor can include an accelerometer that detects movement of the sensor unit housing, such as when the flag pole is moved from the armed position to the disarmed position.

Additionally, the dovetail holder mounting mechanism includes a plurality of flexible fingers, a thumbscrew, and at least one fastener opening. In the first configuration, the thumbscrew is twisted to tighten or loosen the fingers relative to one another to accommodate different sized flag poles. In the second configuration, at least one fastener can be inserted into the base through the at least one fastener opening.

The present invention is directed to an inventive alarm system according to at least one preferred embodiment of the present invention. The alarm system includes at least base unit that is a sensing alarm unit configured with an onboard processor and at least one sensor which is configured for use as a fish strike monitor that is used to monitor a device or apparatus that preferably is a fishing apparatus that more preferably is an ice fishing tip up used outdoors to catch fish. Once the onboard sensor detects that a fish has engaged with the fishing apparatus, the sensor alarm unit issues an alarm via flashing lights, differently colored lights, sounds, vibrations, and combinations or sequences thereof, wireless RF and/or Bluetooth digital communications, including with at least one transportable handheld portable alarm unit, e.g., handheld controller, as well as with one or more smartphones, tables, laptops, computers and the like notifying a user, e.g., fisherman, of the occurrence of a fish strike. Additionally, the alarm system can include multiple sensor alarm units that can be used on fishing apparatuses, such as ice fishing tip ups, at multiple different fishing locations, with each of the sensor alarm units communicating with a controller. The sensor unit housing can be oriented relative to the alarm system in a variety of ways as will further be described below.

One preferred fishing apparatus is a tip up that includes a generally planar base with an opening formed therein between a pair of frame rails in which a tip-up spindle shaft is pivotably mounted to rails. The tip-up spindle shaft includes a coaxial drive shaft attached to rotary spool having a fishing line (not shown) at least partially wrapped around the spool and a hook (not shown) or the like connected to an end of the fishing line that is configured for releasable attachment of bait, such as in the form of a fishing lure, fishing jig, a fly, nightcrawler(s), minnow(s) or another type of fish attracting bait. The tip up has spindle bar located above the spindle shaft that is connected to the drive shaft for rotation in unison therewith when fishing line unspools from the spool when a fish strikes by taking the bait. The tip up includes a flag with a bendable flagpole that is armed by being releasably retained in a generally horizontal fish strike indicator trigger position by part of the flagpole releasably engaging with the spindle bar. The flagpole is anchored to the tip up base and resiliently biased by a coil spring biasing element to spring uprightly into a generally vertical fish strike indicating position when a fish strike the bait unspooling line from the spool rotating the spool, drive shaft and spindle bar disengaging the flagpole therefrom.

The sensor alarm unit has a housing that includes a front sidewall, a back sidewall, and an elongate U-shaped housing holder clip configured to hold the front sidewall and back sidewall together in registry with each other thereby enclosing internal components that include a processor, a wireless receiver, preferably wireless RF transceiver, a power supply, e.g., a single AA or AAA alkaline or lithium battery, one or more lights, e.g., LEDs, an audio transducer, at least one sensor configured for sensing a fish strike, a proximity sensor, a motion sensor, and/or at least one or more of an inclinometer, angle sensor, angular rate sensor, accelerometer, gyroscope, and/or inertial measurement unit (IMIU) and circuit board to which the aforementioned components are mounted to. The sensor alarm unit preferably is equipped with multiple LED lights, such as one or more of Red Green Blue LED lights which are configured to display a plurality of different light intensities, flashing patterns and/or color sequences. The sensor alarm unit may have different magnetic sensors, including one or more MR magnetic sensors that preferably are or include at least one onboard TMR magnetic sensor and preferably a plurality of onboard TMR sensors. The sensor unit housing may include different magnetic sensors, such as a reed switch or but preferably has a TMR sensor, preferably two TMR sensors, and may have other sensors to monitor the position, angle, orientation, and/or movement of the sensor alarm unit, including for instance a position sensor, a motion sensor, an acceleration sensor, a velocity sensor, an angle sensor, a tilt sensor, as well as one or more other sensors. The sensor alarm unit may have one or more user, e.g., fisherman, manipulable controls, e.g., button, configured to change one or more settings, parameters or the like of the sensing alarm unit, such as to be manipulated to pair the sensor alarm unit to at least one transportable portable handheld alarm unit that can be configured with one or more manipulable controls, including at least one control or control setting configured to power on the sensing alarm unit, change a color scheme of the LED lights used to issue a visual or visible alarm, and resetting or rearming the fish strike detecting sensor after detecting a fish strike and tripping the alarm. If desired, the sensing alarm unit has an magnetically attractive magnetic anchor disposed adjacent and preferably inline with an onboard fish strike sensing sensor that preferably is a magnetic sensor.

The sensing alarm unit is mounted by a multiple position or multiple orientation mount to the fishing apparatus, preferably tip up, that releasably attaches to the sensing alarm unit by a twist-lock dovetail joint formed between the sensing alarm unit housing and the mount. The mount can be directly attached to the base of the tip up via an adhesive or using a plurality of fasteners that extend through a bottom wall of the mount. The mount also includes at least one clamp configured for releasable clamping onto the flagpole of the tip up fish strike indicator flag to releasably mount the sensor alarm unit by clamping the clamp onto the flagpole. It is contemplated as being within the scope of the present invention to use a pair of the mounts with one mount attached via a dovetail joint to one end of the sensor alarm unit and releasably clamped to one part of the flagpole and the other mount via a dovetail joint to one end of the sensor alarm unit and releasably clamped to another part of the flagpole.

In a first operating position or orientation, the mount is fixed to the base of the tip up, such as adhesively or using a plurality of fasteners, with the sensing alarm unit releasably attached to the mount via the twist-lock dovetail joint positioning the onboard sensor close enough to the rotatable spindle bar to sensor rotation of the spindle bar from a fish strike. The sensor can preferably be one or more TMR sensors configured to detect a magnetic pole of a fish strike indicator trigger magnet attached to opposite ends of the spindle bar when the spindle bar is rotated by a fish unspooling line from the spool during and after a fish strike. As such, in the event that the rotatable spindle bar and the drive shaft begin to rotate due to pulling of the line from the spool by a fish, each TMR sensor onboard the sensing alarm unit detect(s) any rotations based on movement of the magnets carried by the rotary spindle bar relative to rotation of the rotary spindle bar and/or the drive shaft. For instance, the TMR sensors may detect when a partial spool rotation occurs, when a single spool rotation occurs, when two or more spool rotations occur, when five or ten spool rotations occur, or when the spindle bar, drive shaft and spool continuously rotate. Such an embodiment is advantageous in that it allows a user to detect when only a single or partial rotation occurs, which could occur when the line and/or hook are only briefly moved by a fish or other object, such as when a fish nibbles at a piece of bait but does not engage the hook. This helps to prevent false positive fish strike alarms from being issued, in which case a user would receive an indication from the sensor alarm unit, and approach the sensor alarm unit only to find that the fish did not get hooked by the hook. The sensing alarm unit may be configured to only alert a user when a predetermined number of spool rotations have occurred to avoid wasted time based on false positives where not even a single spool rotation had occurred. Additionally, the TMR sensors can be configured to detect the rotational speed of the spool including at rotational or time intervals, which can provide helpful insight to a user. Where faster speeds of rotation are detected by the sensor that output visual and/or audible alarms enabling speed of spool rotation to estimated remotely by the user, e.g., fisherman, may be useful to help the user to know that he or she needs to quickly proceed to the tip up to check if a fish strike occurred and/or attend to the tip up.

In a second preferred operating position and/or orientation, the sensing alarm unit is releasably clamped or clipped by the mount to the flag pole using a releasable clamp onboard the mount to releasably but securely clamp onto the pole. More specifically, the sensing alarm unit is clipped to the flag pole, after which a thumbscrew of the clamp is twisted or rotated to tighten the clamp jaws against the flagpole positively securing the sensing alarm unit to the flag pole. Once the sensing alarm unit is mounted to the flag pole, the flag pole is urged downwardly against the spring bias of the coil spring until the flag pole is releasably held in place by the rotatable spindle bar, arming the fish strike indicator flag in a generally horizontal trigger position. In the event that the rotatable spindle bar and drive shaft begin to rotate due to pulling of the line from the spool by a fish striking and taking bait attached to the line, the rotatable spindle bar disengages from the flagpole. Because of the force of the coil spring, the flag pole is urged upwardly by the coil spring biasing force. When this occurs, a user can see that the flag and flagpole have been elevated into a generally vertical or upright fish strike indicator position. In addition to the visual representation of the elevated flag, the sensor alarm unit also display various LED light signals, brightness's, on off sequences, etc. providing the user with notice of the occurrence of a fish strike. Because the flag pole moves upwardly, the sensor alarm unit also is in a raised configuration to improve visibility of the LED lights onboard the sensor alarm unit that are also energized to provide light fish strike alarm. In addition to the visual signals, a radio, Bluetooth, or other signal may be transmitted to a portable alarm unit on the person of a user who is remotely located a further distance away, or visually blocked from being able to see the light of the sensor alarm unit, such as when the user is indoors. A magnet mounted on the base of the tip up causes the TMR magnetic sensor to trigger upon movement of the magnetic sensor and senor alarm unit away to magnet when elevated with flagpole when disengaged from the spindle bar. When the flag pole is moved from the lowered generally horizontal armed position to the raised fish strike indicating position, the sensor separates from the magnet triggering the sensor to cause one or a visible or audible fish strike indicator and/or spool rotation alarm to be outputted by the sensor alarm unit.

In yet another sensor alarm unit operating position and/or orientation, the sensor alarm unit may be mounted to the rotatable spindle bar and/or the drive shaft of the tip up. In such an embodiment, the sensor alarm unit would be configured to detect movement of the rotatable spindle bar and/or the drive shaft for instance using an accelerometer, position sensor, a motion sensor, a velocity sensor, an angle sensor, a tilt sensor, or another type of sensor. Thus, in the event that the rotatable spindle bar and the drive shaft begin to rotate due to pulling of the line from the spool by a fish, at least one of the above-identified sensors onboard the sensing alarm unit can detect this movement and alert a user. Much like the first orientation described above, the settings of the sensing alarm unit can be adjusted such that an alert is only sent when a threshold amount of rotation occurs so as to avoid false positives. Similarly, additional information such as the number of rotations, speed of rotations, etc. could be monitored, and the user can be notified accordingly.

Regardless of the orientation, when a user is alerted of a fish strike, he or she can check the tip up for fish upon issuance of one of a fish strike alarm and/or spool rotation alarm, and rearm the sensor alarm unit if needed.

The present invention thereby also is directed to a fishing equipment alarm system and more particularly to a sensing alarm unit thereof that is well suited for outdoor use with an ice fishing tip up and other types of fishing apparatuses, such as other types of fishing reels, and which is equipped with an onboard magnetic field sensor, e.g., magnetic sensor, configured for more sensitive and/or selective magnetic field or flux sensing that preferably is a magnetoresistance sensor or MR sensor, which more preferably is a tunneling magnetoresistance sensor or TMR sensor, positioned and/or orientated relative to one or more sensor triggering magnets in one or more sensor trigger magnet arrangements where each magnet can be spaced from the magnetic sensor(s) of the sensing alarm unit a distance whereby there is an air gap between the onboard magnetic sensor(s) and adjacent triggering magnet passing by the sensor(s) during rotation of one or more components of a fishing apparatus indicative of a fish strike, and whose magnets can be positioned at varying magnetic pole angles and magnetic pole orientations relative to the sensor(s), preferably TMR sensors, as well as be located different directions in front of, behind, above, below and on either side of the magnetic sensor(s), preferably TMR sensor(s), during operation of the sensing alarm unit during fishing apparatus operation.

The sensor alarm unit preferably is configured to be releasably clamped to one of a flagpole of an ice fishing tip up, a fishing reel and drive assembly drive shaft of the tip up, and a spindle bar or crossbar of the tip up that fixed to the drive shaft of the tip up. The sensor alarm unit can have one or more of an accelerometer, gyro, tilt sensor, inclination sensor or another type of sensor configured for detecting sensor alarm unit when a tip up flagpole is released by or during a fish strike and/or configured for detecting sensor alarm unit and drive shaft rotation, spindle bar rotation and/or crossbar rotation when releasably mounted to the tip up drive shaft, spindle bar or cross bar of the tip up.

These and other objects, features and advantages of this invention will become apparent from the following detailed description of the invention and accompanying drawings.

### DRAWING DESCRIPTION

One or more preferred exemplary embodiments of the invention are illustrated in the accompanying drawings in which like reference numerals represent like parts throughout and in which:

FIG. 1 is a top front perspective view of an alarm system of the invention that includes a sensor carrying alarm unit releasably clamped to a flagpole of an ice fishing tip up fishing apparatus with the tip up and alarm unit armed with a tip up fish strike indicator flag and alarm unit in a generally horizontal fish strike indicator trigger position;

FIG. 2 is a fragmentary rear perspective view of the tip up and sensor carrying sensing alarm unit of FIG. 1 illustrating a removable twist-lock mount removably attached to one end of a housing of the alarm unit and having a resilient clamp with a pair of jaws clamped around the generally cylindrical or tubular flagpole of the fish strike indicator flag of the tip up;

FIG. 3 is a side elevation view of the tip up and sensing alarm unit shown in FIGS. 1 & 2;

FIG. 4 is an enlarged fragmentary side view of the portion of the tip up and the sensing alarm unit showing an air gap 47 between a sensor triggering magnet mounted to the base of the tip up and a magnetic sensor onboard the sensing alarm unit that senses a magnetic field, change in magnetic field, magnetic flux and/or change in magnetic flux to detect occurrence of a fish strike during tip up fishing use;

FIG. 5 is an enlarged top front perspective view of part of the tip up showing the construction of the sensing alarm unit, its housing and the clamp of the twist-lock mount in more detail;

FIG. 6A is a first top rear perspective view of the tip up and the sensing alarm unit fixed by the mount to a ground of the tip up by being fixed to the base of the tip with the sensing alarm unit oriented uprightly relative to the base with its magnetic sensor positioned to detect a magnetic field, magnetic flux and/or changes therein of a first embodiment of a magnetic sensor trigger magnet arrangement composed of pair of spaced apart sensor trigger magnets arranged with their common poles facing or extending radially oppositely outwardly and mounted at opposite ends of a spindle bar or cross bar of the tip up that releasably retains the fish strike indicator flag in the generally horizontal armed position whereby the magnets rotate in unison with the spindle bar or cross bar when a fish strike occurs;

FIG. 6B is a second top rear perspective view of the tip up and the sensing alarm unit of FIG. 6A with a second embodiment of a magnetic sensor trigger magnet arrangement composed of pair of spaced apart sensor trigger magnets arranged with opposite poles facing or extending radially oppositely outwardly and mounted at opposite ends of a spindle bar or cross bar of the tip up;

FIG. 6C is a third top rear perspective view of the tip up and the sensing alarm unit of FIG. 6A with a third embodiment of a magnetic sensor trigger magnet arrangement composed of single sensor trigger magnet arranged axially parallel to and alongside the spindle bar or cross bar;

FIG. 6D is a fourth top rear perspective view of the tip up and the sensing alarm unit of FIG. 6A with a fourth embodiment of a magnetic sensor trigger magnet arrangement that is a housing configured for carrying at least one sensor trigger magnet and for releasable attachment to one of the spindle bar, crossbar and/or tip up rotary fishing reel drive shaft;

FIG. 7 is a fragmentary front elevation view of the sensing alarm unit and part of the tip up with a pair of magnets attached to opposite ends of the spindle bar with the magnetic poles facing or extending transversely relative to the spindle bar and the magnetic sensor onboard the sensing alarm unit;

FIG. 8 is a bottom perspective view of the mount releasably attached to the sensing alarm unit illustrating (a) a circular pedestal or base of the mount having a pair of mounting fastener through holes and a pair of generally half-moon shape through openings on either side of an elongate mounting panel of the pedestal or base, and (b) each one of the resiliently flexible jaws of the tip up flagpole mounting clamp along with an opening extending transversely therethrough for accommodating a clamp jaw tightener or clamp jaw clamping force adjuster;

FIG. 9 is a fragmentary enlarged perspective view depicting (a) the twist lock dovetail joint in more detail and the thumbscrew of the clamp jaw tightener or force adjuster being received in the aligned through bores extending through each clamp jaw; and (b) the substantially symmetrical pair of spaced apart and outwardly flared male dovetail ears that respectively extend outwardly from a bottom or end wall of each one of the boxlike housing panels that form the sensor alarm unit housing;

FIG. 10 is a top perspective view of the body of the mount including the pedestal or base of the mount showing in more detail in elongate generally rectangular dovetail twist lock receiving recess with elongate sidewalls having a generally arcuately outwardly extending section forming an enlarged generally circular dovetail insertion receptacle which receive the ears of the male dovetail of the sensing alarm unit housing before twisting of the sensing alarm unit housing relative to the mount pedestal or base is performed to releasably and substantially immovably lock the mount to the sensing alarm unit housing;

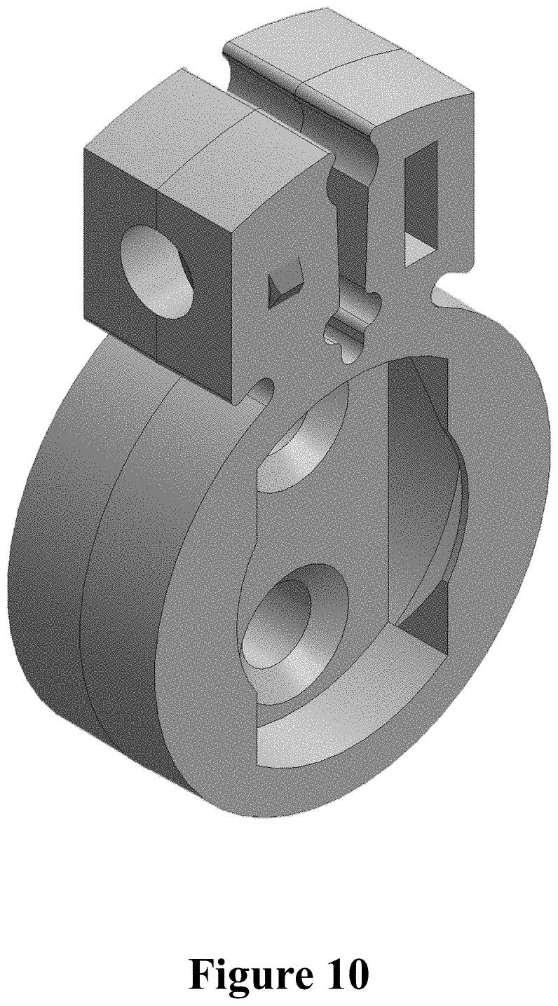

FIG. 11 is a rear perspective view of the body of the mount that shows the twist lock dovetail receiving receptacle formed, preferably integrally formed, more preferably formed by molding into the top surface of the body of the mount;

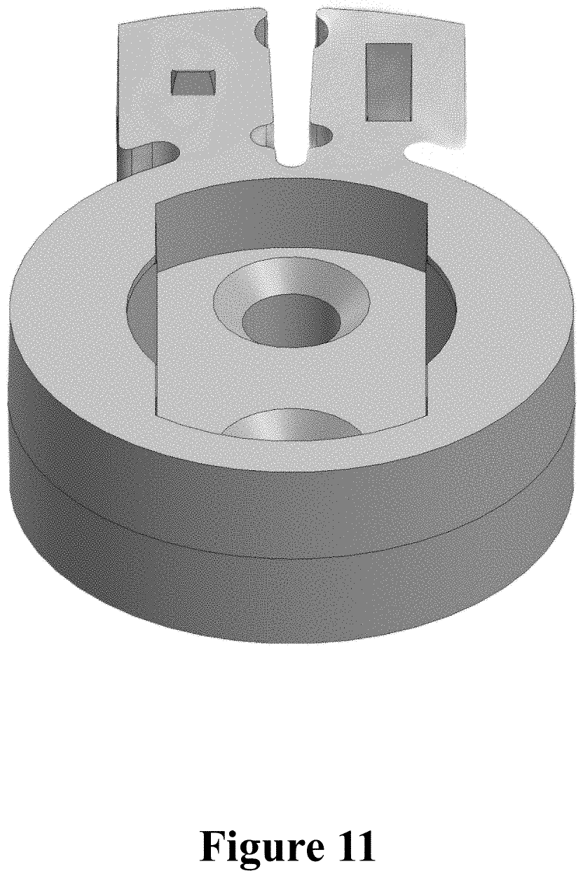

FIG. 12 is a top plan view of the body of the mount showing in more detail the twist lock dovetail receiving receptacle formed therein

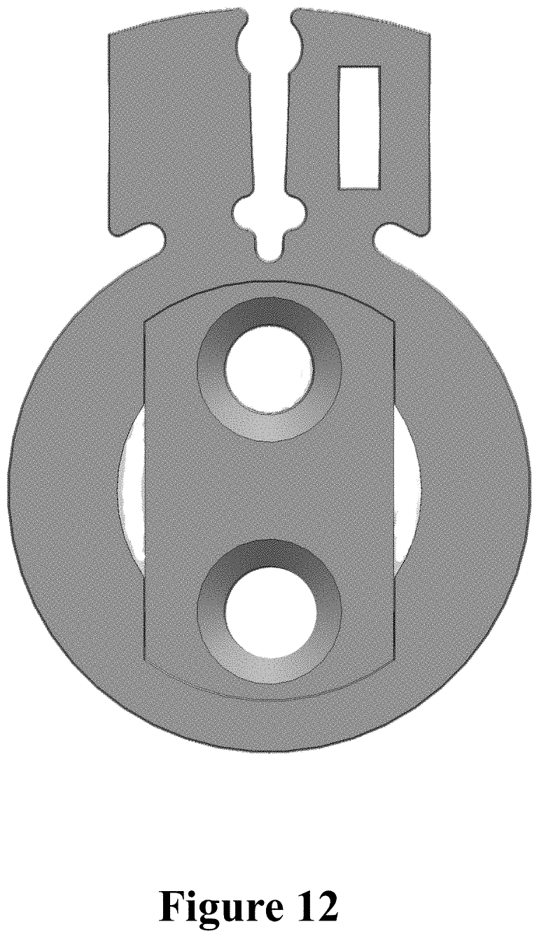

FIG. 13 is a bottom plan view of the body of the mount;

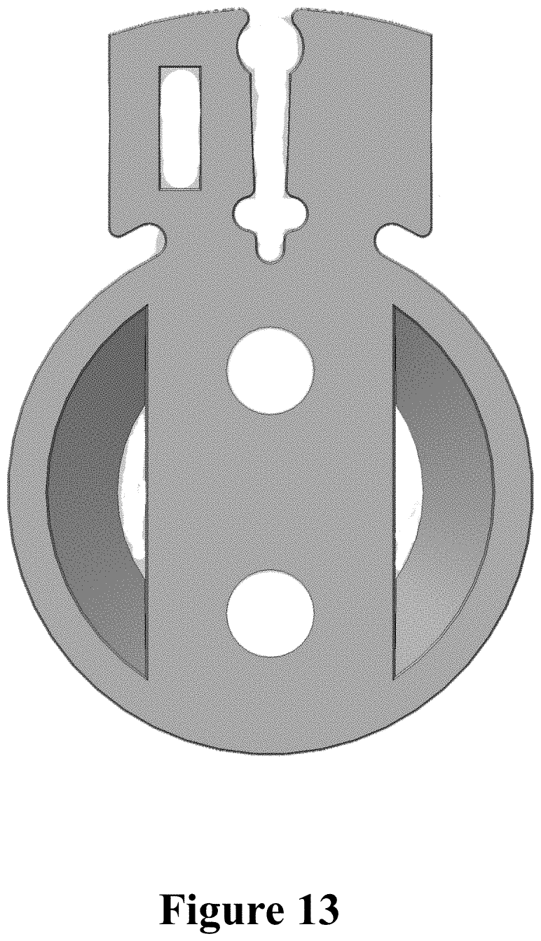

FIG. 14 is a front bottom perspective view of the body of the mount with the clamp jaws facing forwardly showing both clamp jaws of the flagpole clamp in more detail;

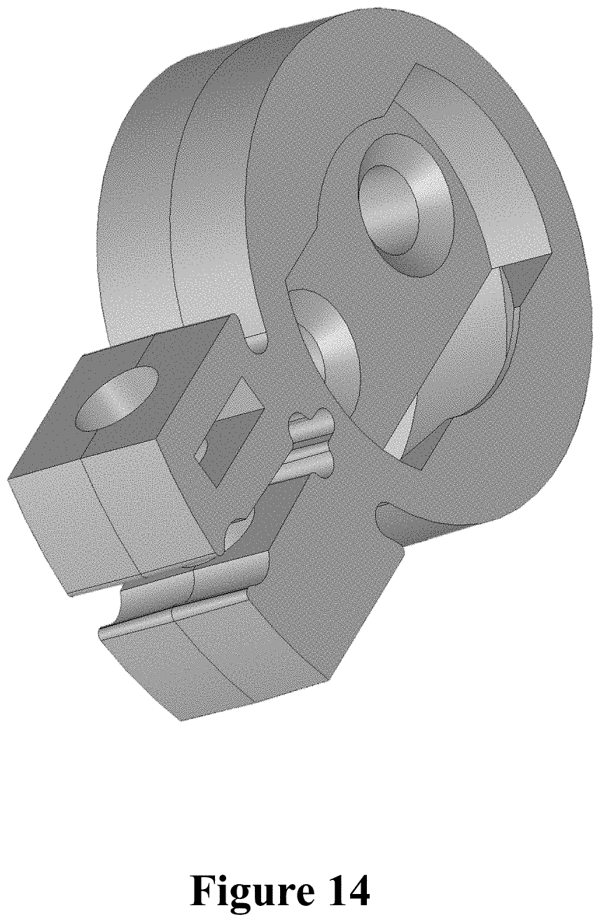

FIG. 15 is a front elevation view of the body of the mount;

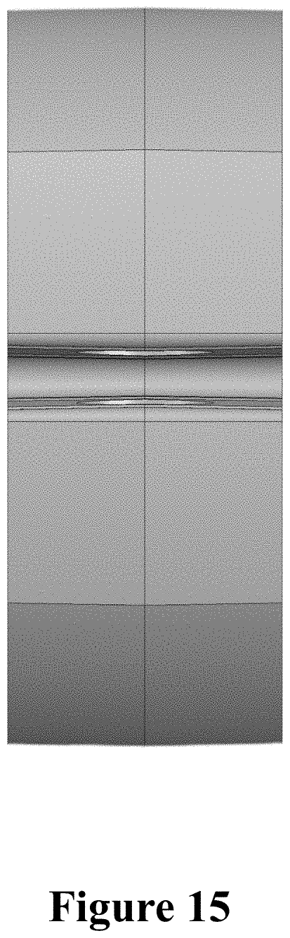

FIG. 16 is a rear elevation view of the body of the mount; and

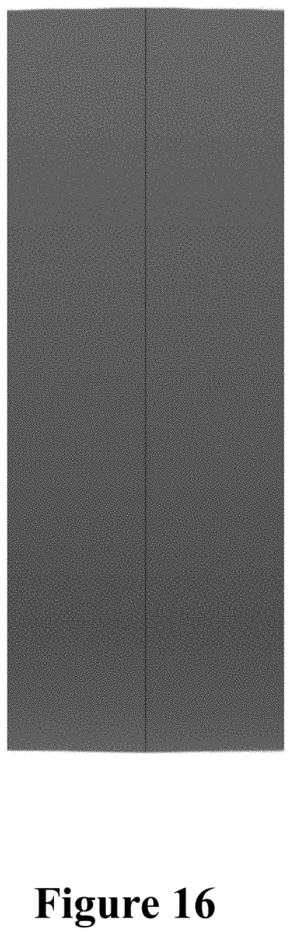

FIG. 17 is a right side elevation view of the of the body of the mount with the left side elevation view of the body of the mount being substantially identical thereto.

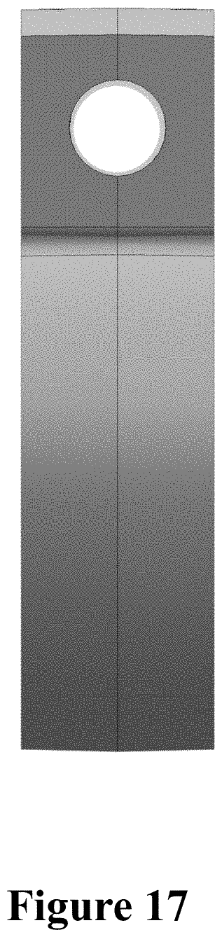

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

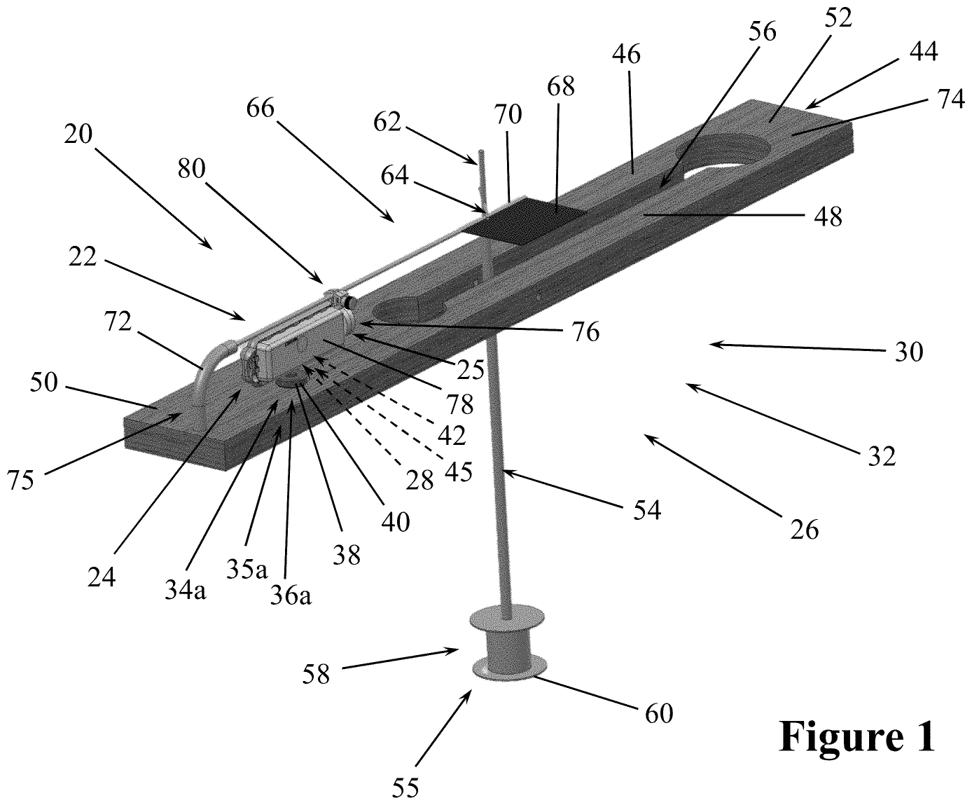

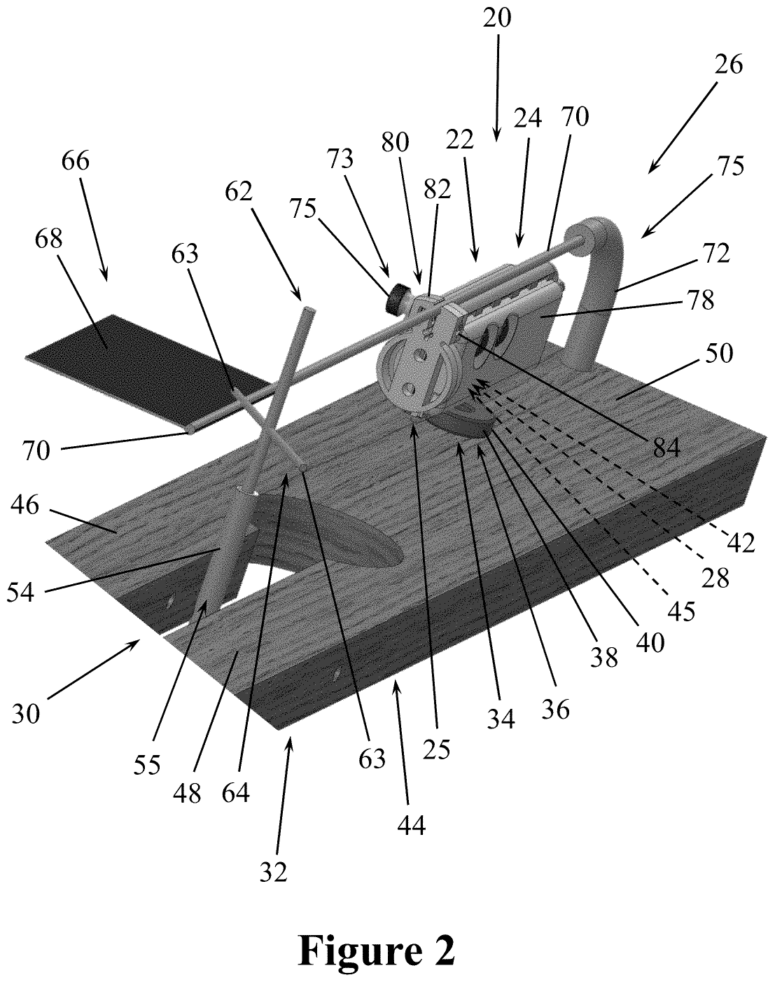

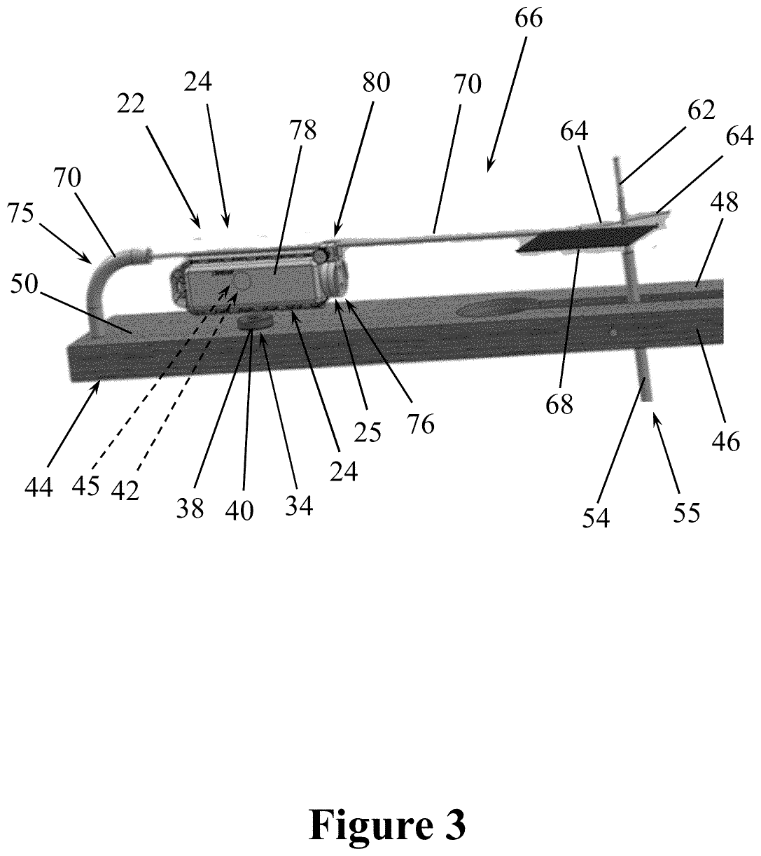

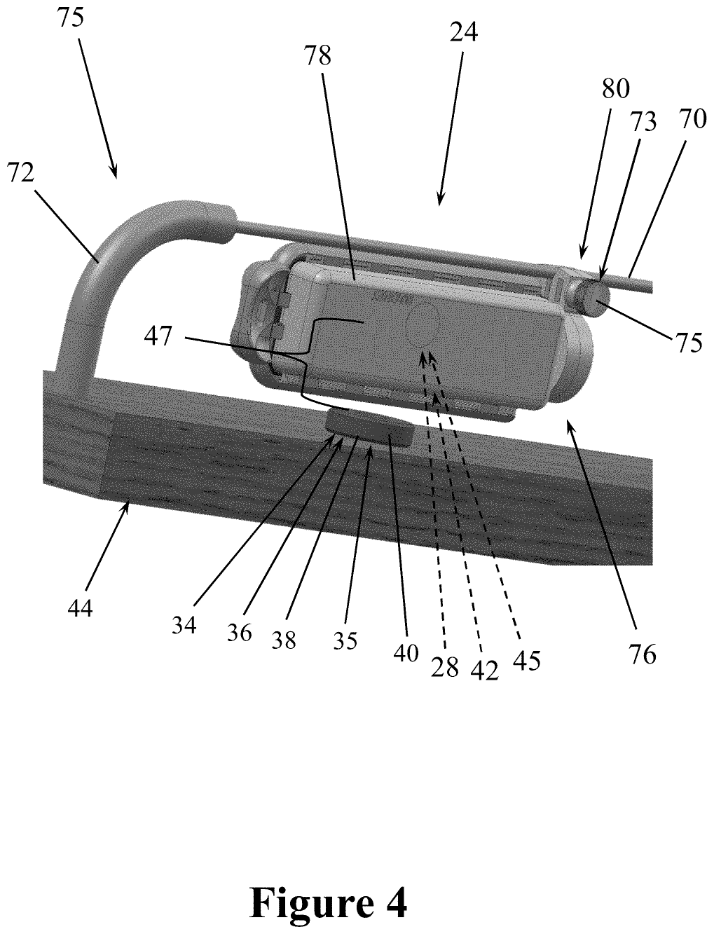

FIGS. 1-5 illustrates an inventive alarm system 20 according to a preferred embodiment of the present invention. The alarm system 20 includes a base unit 22 that is a sensing alarm unit 24 configured to sense operation of an apparatus 26 located in close proximity, carried thereby and/or attached thereto and output an alarm upon the sensing of the occurrence of a predetermined condition, parameter, or event of the apparatus 26 that is related to operation or performance of the apparatus 26. The sensing alarm unit 24 has at least one sensor 28 onboard the unit 24 used to detect a predetermined condition or parameter of the apparatus 26 that is related to apparatus operation and issue an alarm when a sensing alarm event occurs where the sensed predetermined condition or parameter exceeds or falls below a predetermined threshold, e.g., threshold value, falls outside a predetermined threshold range, e.g., falls outside a predetermined minimum value or maximum value, or falls within a predetermined threshold range, e.g., falls within a predetermined minimum value or maximum value. Although the sensor 28 is not directly shown, the sensor 28 preferably is mounted to a circuit board 33 enclosed within a housing 78 of the sensing alarm unit 24. The sensor 28 preferably is positioned in close enough proximity relative to a movable component of the apparatus 26 to sense movement, e.g., displacement, translation, change in orientation, change in angle, and/or rotation of the movable component during operation of the apparatus 26. The sensing alarm unit 24 is configured to provide at least one type of human perceptible alarm, e.g., output a visual or audible alarm, and can be configured to sequentially and/or substantially simultaneously output a plurality of types of human perceptible alarms, e.g., output both a visual and audible alarm, visually and/or audibly detectable by a user of the apparatus 26 upon the occurrence of a sensing alarm event.

In a preferred system 20 employing at least one base unit 22 that is a sensing alarm unit 24, the unit 24 is configured to wirelessly communicate a sensing alarm event message to a handheld portable user-transportable alarm unit (not shown), which can be configured as a controller (not shown) of the sensing alarm unit 24, and which is configured to output at least one and preferably at least a plurality of an audible alarm, e.g., audibly detectable alarm, a visual alarm, e.g., a visually detectable alarm, and/or a haptically detectable alarm, e.g., vibratory alarm, upon receiving the wireless sensing alarm event message. Each sensing alarm unit 24 and portable alarm unit (not shown) each have an onboard digital wireless communications system respectively configured to enable wireless digital messages, including sensing alarm event messages, to be transmitted from the sensing alarm unit 24 and received by a portable alarm unit (not shown) configured to receive wireless communications from at least a plurality of different sensing alarm units 24 of the system 20. Where the portable alarm unit (not shown) is also a controller (not shown) configured to remotely control one or more aspects of sensing alarm unit operation, each sensing alarm unit 24 and portable alarming controller (not shown) each have an onboard bidirectional digital wireless communications system enabling bidirectional exchange of digital wireless messages, including status messages from each unit 24 to the controller, status request messages from the controller to one or more units 24, sensing event and sensing alarm event messages from each unit 24 to the controller, and control messages from the controller to one or more units 24 enabling control of one more aspects of operation thereof. Such a system 20 is composed of at least one base unit 22 that is a sensing alarm unit 24 and can include at least one alarm unit and/or controller (not shown) capable of bidirectional digital wireless communication with a plurality of the sensing alarm units 24 can be constructed and arranged and configured to operate in accordance with the corresponding system, sensing base units, and portable transportable controller disclosed in commonly owned U.S. Pat. No. 10,827,735, the entirety of which is hereby expressly incorporated by reference herein.

With specific reference to FIGS. 1-3, the sensing alarm unit 24 of the present invention is releasably mounted by a mounting arrangement 25 to an apparatus 26 that is a fishing apparatus 4, such as preferably an ice fishing tip up 32, and which is disposed with its onboard sensor 28 located in close enough proximity to a component of or part of the apparatus 26, preferably fishing apparatus 30, more preferably tip up 32, such that relative movement therebetween during operation of the apparatus 26, preferably fishing apparatus 30, more preferably tip up 32, triggers the sensor 28 resulting in issuance of a sensing alarm event signal, e.g., interrupt, therefrom which in turn causes a processor (not shown) onboard the unit 24 to output an alarm from the unit 24 notifying a user located in the vicinity of the unit 24 of the occurrence of a sensing alarm event, such as an event indicative of a fish strike. Although the processor is not shown, the processor preferably is mounted to a circuit board 33 onboard the sensing alarm unit 24 that is enclosed within the sensor alarm unit housing 78. Where the system 20 includes a portable alarm unit (not shown) carried on the person of a user who is remotely located away from the sensing alarm unit 24, a wireless sensing alarm event message is communicated to the portable alarm unit causing a processor (not shown) onboard the portable alarm unit to also output an alarm notifying the user of the occurrence of the sensing alarm event, e.g., fish strike.

In use and operation, the sensor 28 of the sensing alarm unit 24 is disposed in close proximity relative to a sensor trigger arrangement 34 mounted to or carried by a component or part of the apparatus 26, preferably fishing apparatus 30, more preferably tip up 32, and which is configured to trigger the sensor 28 upon the occurrence of relative movement therebetween. Upon relative movement therebetween causing either the sensor trigger arrangement 34 to move away from the sensor 28 or the sensor 28 to move away from the sensor trigger arrangement 34 due to movement of the apparatus part or component during apparatus operation, the sensor 28 outputs an electrical signal, e.g., interrupt, to the onboard processor (not shown) of the sensing alarm unit 24 thereby causing the alarm to be emitted by the unit 24.

The sensor trigger arrangement 34 includes a sensor trigger 36 configured to operatively couple with the sensor 28 of the sensing alarm unit 24, even when spaced apart a sensor set or trigger distance by a space or gap therebetween, and trigger the sensor 28 upon the occurrence of a change in the distance between the sensor trigger 36 and sensor 28 by the space or gap between them either widening or narrowing compared to the original set or trigger distance as a result of apparatus movement during operation of apparatus 26. In a preferred embodiment and method of operation, the sensing alarm unit 24, including its onboard sensor 28 and/or onboard processor (not shown), is or are configured, including in firmware and/or software, to cause the sensor 28 to trigger thereby causing the sensing alarm unit 24 to alarm upon a sensed change in the distance between the sensor 28 and the sensor trigger 36 from an original preset or predetermined set or trigger distance therebetween due to apparatus component or part movement during operation of apparatus 26. In this manner, a sensing alarm unit 24 of the present invention is configured or can be configured to sense movement of a part or component of the apparatus 26, preferably relative to the sensor 28 of the sensing alarm unit 24, indicative of the occurrence of an event, condition, phase, orientation, position or the like of the apparatus 26 that can arise or which typically does occur during operation of the apparatus 26 that a user of the apparatus 26 desires to monitor so that an alarm can be provided notifying the user of the apparatus 26 of the occurrence of the event, condition, phase, orientation, position, or the like of the apparatus 26.

In at least one embodiment and method of operation, the sensing alarm unit 24, including its onboard sensor 28 and/or processor (not shown), is or are configured, including in firmware and/or software, to enable an initial predetermined or preset distance between the sensor 28 and sensor trigger 36 to be set as a predetermined or preset set or trigger distance with the sensor 28 and/or processor (not shown) onboard the sensing alarm unit 24 preferably further configured, including in software and/or firmware, to sense a change in the distance between the sensor 28 and sensor trigger 36 deviating from the initial set or trigger distance due to the occurrence of relative movement therebetween caused by apparatus operation and trigger the sensing alarm unit 24 to alarm. In a preferred embodiment and method of operation, the sensing alarm unit 24, including its onboard sensor 28 and/or processor (not shown), is or are configured, including in firmware and/or software: (a) to allow a user to selectively record or set an initial predetermined or preset distance between the sensor 28 and sensor trigger 36 as the predetermined or preset set or trigger distance, (b) to sense or detect movement of a component or part of the apparatus caused during operation of the apparatus by sensing or detecting a change, preferably an increase, in the distance between the sensor 28 and sensor trigger 36, and (c) trigger the sensing alarm unit 24 into outputting an alarm to the user of the occurrence of movement of the component or part of the apparatus. As such, a sensing alarm unit 24 of the present invention also can be configured or is configured to sense movement of at least one part or component of the apparatus 26, preferably relative to the sensor 28 and/or relative to the sensing alarm unit 24, indicative of the occurrence of an event, condition, phase, orientation, position or the like of the apparatus 26 that can arise during operation of the apparatus 26 that a user of the apparatus 26 desires to monitor and provide an alarm notifying the user that the event, condition, phase, orientation, position, or the like of the apparatus 26 being monitored by the sensing alarm unit 24 has occurred.

In the preferred embodiment depicted in FIGS. 1-5, the sensor trigger 36 of the sensor trigger arrangement 34 preferably is or includes at least one trigger magnet 38, each of which is a source of a magnetic field, flux and/or flux density emitted therefrom, each of which can be a steady-state magnetic field, flux and/or flux density source, and each of which preferably is a permanent magnet 40, such as a rare earth magnet. Such a sensor trigger arrangement 34 is a magnetic sensor trigger arrangement 35 that includes or consists of a magnetic sensor trigger 36 that is or consists of at least one trigger magnet 38.

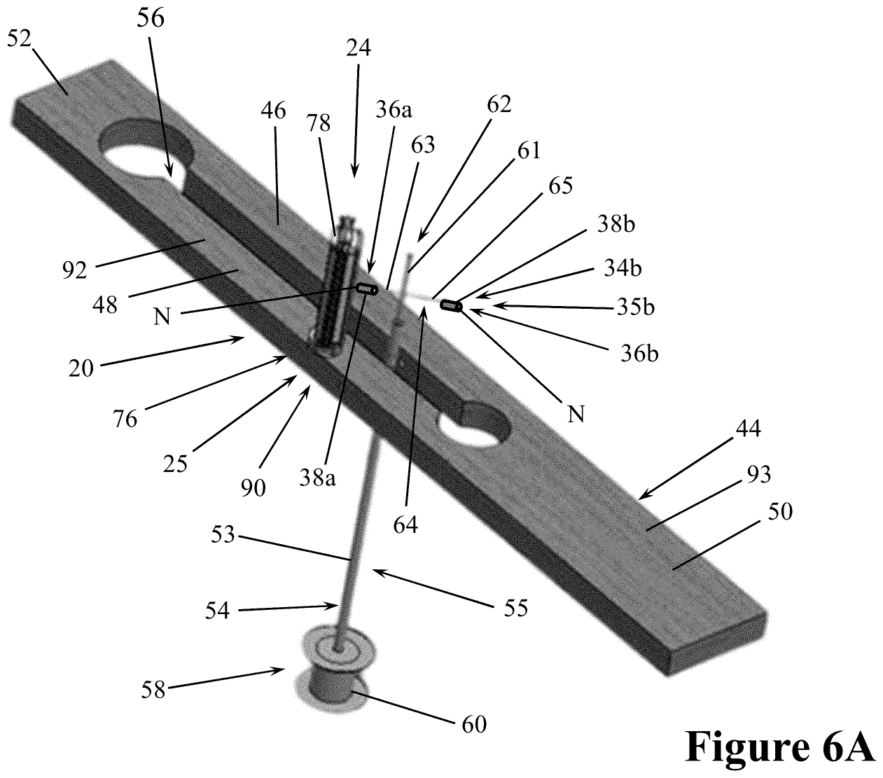

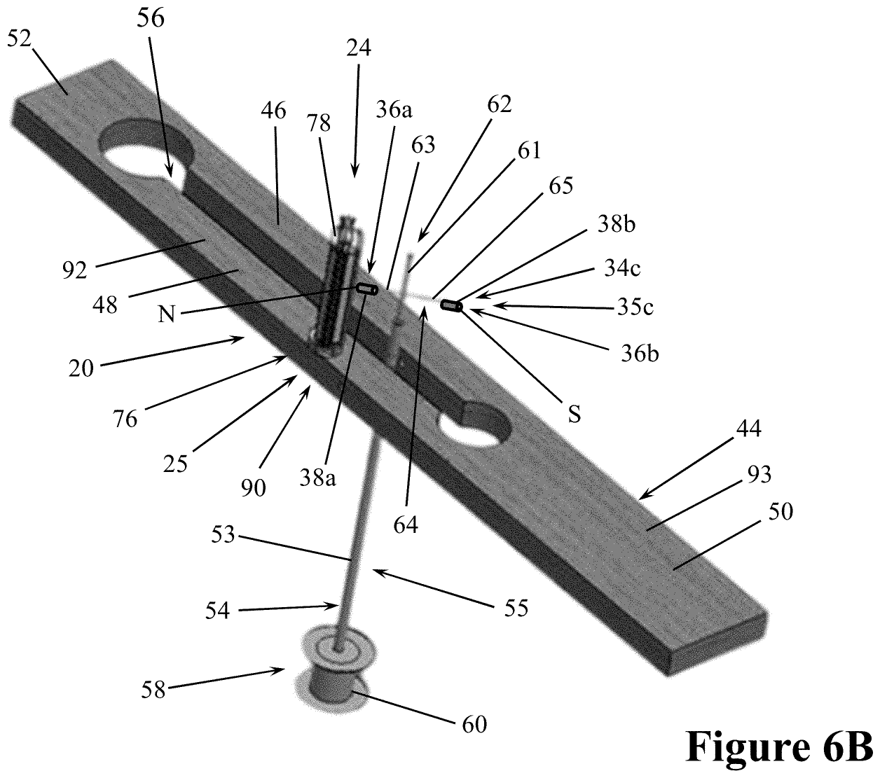

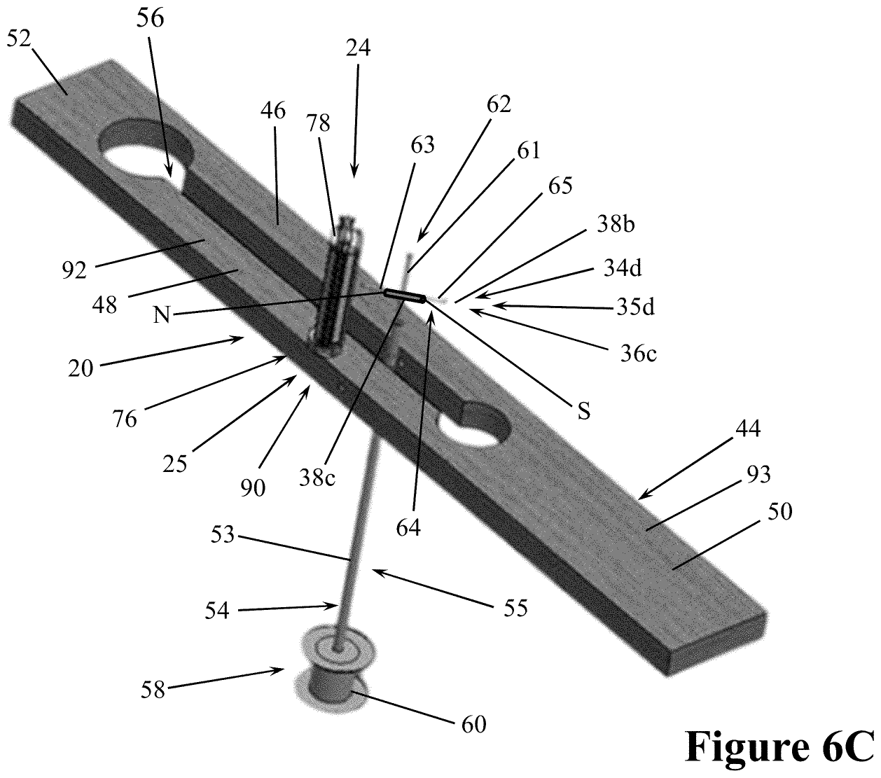

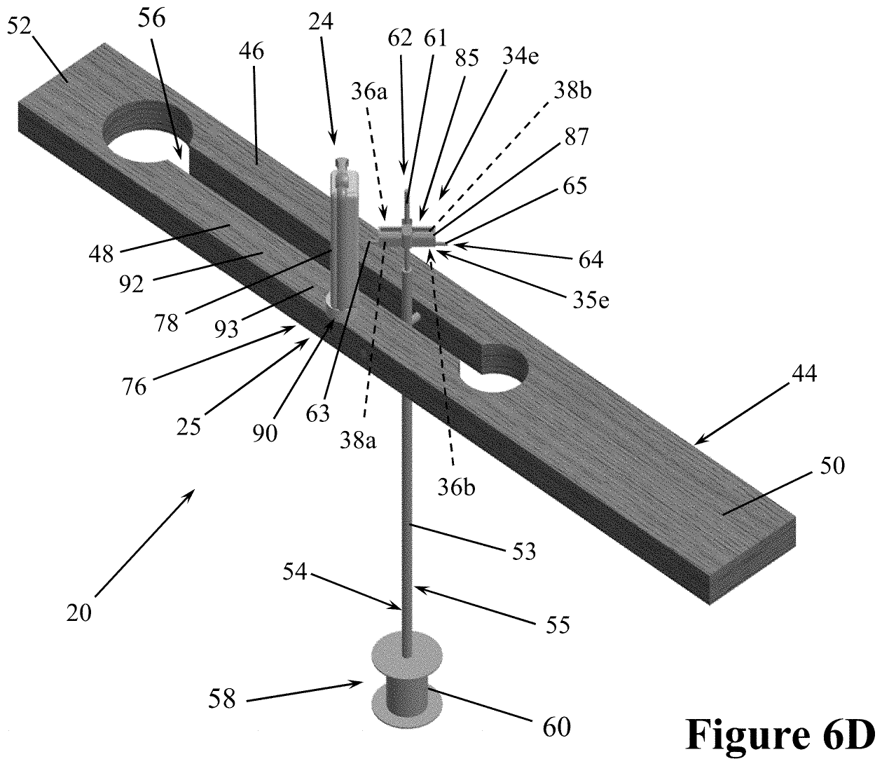

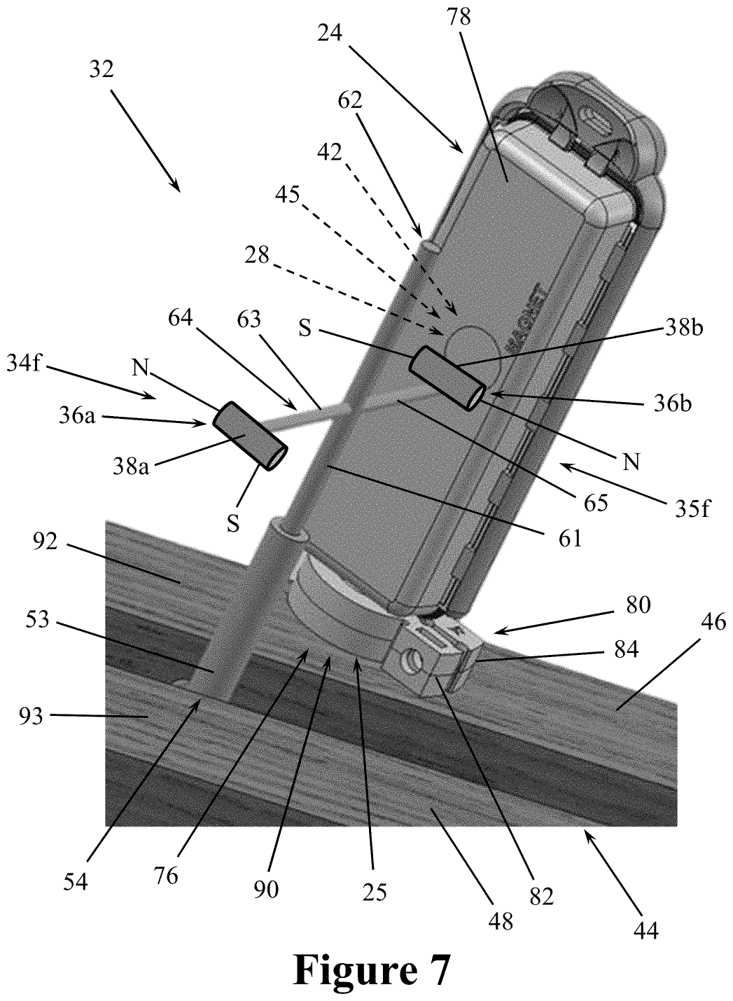

While the sensor trigger arrangement 34a shown in FIGS. 1-5 is a magnetic sensor trigger arrangement 35a that consists only of a single trigger magnet 38 in the form of a single annular, round, circular, or disc-shaped permanent magnet 40 immovably fixed to part of the apparatus 26, a sensor trigger arrangement 34b, 34c, 34d, 34e, preferably a magnetic sensor trigger arrangement 35b, 35c, 35d, 35e, as depicted in FIGS. 6A-6D, and/or a sensor trigger arrangement 34f, preferably magnetic sensor trigger arrangement 35f of FIG. 7 can be used that are respectively carried by or mounted to a spindle bar 64 or crossbar 64 fixed to an elongate shaft or rod 61 of a rotary drive shaft 62 of a rotary reel and drive assembly 55 of the tip up 32 where the shaft or rod 61 is coaxially telescopically received in an elongate cylindrical tube 54, preferably a driveshaft rotation guide or bearing sleeve 53. The shaft or rod 61 of the drive shaft 62 has one end operatively connected, such as by being fixed, to a rotary reel 58 and configured to rotate in unison with the reel 58 when a fish takes bait attached to fishing line extending from a spool 60 of the reel 58. The spool 60 can be an integral part of the reel 58 or a removable component carried by the reel 58 and which rotates the reel 58 in unison therewith when a fish strikes bait attached to fishing line extending from and wrapped around the spool 60. A crossbar 64 is oriented perpendicularly relative to the drive shaft 62 and fixed to the shaft or rod 61 of the drive shaft 62 such that the crossbar 64 rotates in unison therewith when a fish strikes bait and unspools line from the spool rotating the spool 60 thereby rotating the reel 58 in turn causing the drive shaft 64 to rotate. The crossbar 64 has a pair of oppositely extending crossbar bar segments 63, 65 that extend generally perpendicularly outwardly from the shaft or rod 61 of the drive shaft 62 in opposite directions. As depicted in the drawing figures showing a tip up 32, one of the bar segments 63 or 65 of the crossbar 64 operatively engages with a flagpole 70 of the tip up 32 to retain the flagpole 70 in a set position and disengages from the flagpole 70 when a fish strike causes the reel 58 to rotate the driveshaft 62 which in turn causes the crossbar 64 to rotate.

In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly.

Each one of the magnets 38a, 38b has a north (N) pole and a south (S) pole and configured so a respective one of the magnets 38a, 38b is oriented on or relative to the corresponding crossbar segment 63, 65 carrying the magnet so that one of the north and south poles of each magnet 38a, 38b faces outwardly away from the shaft or rod 61 of the drive shaft 62 of the tip up 32 so as to be detectable by a magnet sensor 42, preferably TMR sensor 45, during rotation of the crossbar 64 during a fish strike. In a preferred embodiment, each one of the magnets 38a, 38b is oriented with the same magnetic pole facing outwardly such that each one of the magnets 38a, 38b is oriented either with its north pole facing outwardly or its south pole facing outwardly. In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly.

Preferred embodiments of a magnetic sensor trigger arrangement 35b, 35c, and/or 35e depicted in FIGS. 6A, 6B and 6D, discussed in more detail below, include at least a plurality of the trigger magnets 38a and 38b, with (a) one of the magnets 38a carried by one bar segment 63 of the crossbar 64 and configured for movement, preferably rotation, in unison with the bar segment 63 during a fish strike, and (b) another one of the magnets 38b carried by the other bar segment 65 of the crossbar 64 and configured for movement, preferably rotation, in unison with the bar segment 65 during a fish strike. In a preferred embodiment, each one of the trigger magnets 38a are fixed to a corresponding one of the bar segments 63, 65 for rotation in unison with the bar segments 63, 65 during rotation of the crossbar 64 by the shaft or rod 61 of the driveshaft 62 when a fish strikes bait and unspools line from the spool 60 rotating the reel 58. In the additional embodiment of a magnetic sensor trigger arrangement 35d shown in FIG. 6C and also discussed in more detail below, there is a single sensor trigger that preferably is a single sensor trigger magnet 38c mounted to the spindle bar or crossbar 64 of the tip up 32 for rotation in unison with the crossbar during a fish strike.

As is shown in FIGS. 6A-6D & 7, the crossbar 64 is elongate and generally straight with the one crossbar segment 63 thereof generally coaxial and axially inline with the other crossbar segment 65. As is also shown in FIGS. 6A-6D & 7, the one magnet 38a is a generally cylindrical magnet 38a that is fixed to or caps the free end of the one bar segment 63 of the spindle bar 64 and the other magnet 38b also is a generally cylindrical magnet 38b that is fixed to or caps the free end of the other bar segment 65 of the spindle bar 64. As is shown in FIG. 7, each one of the trigger magnets 38a, 38b is oriented generally transversely, e.g., tangential, to the corresponding bar or segment 63, 65 of the spindle bar 64 to which the respective magnet 38a, 38b is attached orienting the magnetic poles of each magnet such that magnetic field or magnetic flux extends generally transversely relative to the magnetic sensor 42, preferably TMR sensor 45, when each magnet 38a, 38b passes by the magnetic sensor 42 during rotation of the spool 60, drive shaft 62 and spindle bar 64 during tip up fishing apparatus operation. If desired, each one of the magnets 38a, 38b can be mounted to the respective bar or segment 63, 65 of the spindle bar 64 with the poles of each magnet 38a, 38b facing parallel to the bars or segments 63, 65 of the spindle bar 64 as depicted in FIG. 6A.

In a preferred embodiment, the sensor alarm unit 24 has at least a pair of the TMR sensors 45 arranged on oppositely facing sensing directions with one of the TMR sensors 45 facing in one direction and the other one of the TMR sensors 45 facing in the other direction (oppositely facing oppositely sensing pair of TMR sensors). In another preferred embodiment, the sensing alarm unit 24 has four onboard TMR sensors 45 arranged in a magnetic sensor array with a first pair of oppositely facing oppositely facing TMR sensors 45 and a second pair of oppositely facing oppositely facing TMR sensors 45 orthogonally oriented relative to the first pair of oppositely facing oppositely facing TMR sensors 45. Such a sensing alarm unit 24 with at least one pair of oppositely facing oppositely facing TMR sensors 45 and preferably an array of the two pairs of oppositely facing oppositely facing TMR sensors 45 enables the sensing alarm unit 24 to sense trigger magnets 38a, 38b located above, below, in front of, behind, to the right side of, or to the left side of the sensor alarm unit 24 preferably substantially simultaneously. In addition, such a sensing alarm unit 24 with at least one pair of oppositely facing oppositely facing TMR sensors 45 and preferably an array of the two pairs of oppositely facing oppositely facing TMR sensors 45 enables the sensing alarm unit 24 to sense trigger magnets 38a, 38b arranged at all different angles, including diagonally, above, below, in front of, behind, to the right side of, or to the left side of the sensing alarm unit 4 including offset to one side or the other side of the TMR sensors 45 and even offset a distance to one side or the other side of the sensing alarm unit housing 78 such that is an air gap of at least one inch and preferably as much as two inches, i.e., sensing range of between 1-2 inches, and being able to be sensed by one or more of the TMR sensors 45.

With reference to FIGS. 6A-6D, there is at least one sensor trigger 36a, 36b, and/or 36c, each of which preferably is a sensor trigger magnetic source, such as a steady state source of a magnetic field or flux, which more preferably is a permanent magnet sensor trigger magnet, such as one or more of the pair of sensor trigger magnets 38a, 38b depicted in FIGS. 6A-6B and 7, the single sensor trigger magnet 38c depicted in FIG. 6C, and/or the sensor trigger magnet(s) 38a, 38b of the sensor trigger magnet arrangement 85 of FIG. 6D. It should also be noted that the sensor trigger magnet arrangement 85 of FIG. 6D can contain a pair of sensor trigger magnets 38a, 38b, such as depicted in FIG. 6D, a single sensor trigger magnet 38c, like the single magnet 38c depicted in the trigger magnet arrangement 35c of FIG. 6C, or even a plurality of pairs of, i.e., at least three, of the sensor trigger magnets, such as both the magnets 38a, 38b of FIGS. 6A, 6B & 6D and also one or more additional spaced apart magnets like magnets 38a, 38b &/or 38c. Each one of the magnets 38a, 38b, 38c has a north (N) pole and a south (S) pole and configured so at least a respective one of the magnets 38a, 38b and/or 38c is oriented on or relative to the corresponding crossbar segment 63, 65 carrying the magnet so that one of the north and south poles of each magnet 38a, 38b or 38c faces outwardly away from the shaft or rod 61 of the drive shaft 62 of the tip up 32 so as to be detectable by a magnet sensor 42, preferably TMR sensor 45, during rotation of the crossbar 64 during a fish strike. Where the sensor alarm unit 24 has a plurality of spaced apart magnet sensors 42, preferably at least a pair of TMR sensors 45, each one of the magnets 38a, 38b or 38c is sequentially detectable and preferably sequentially detected by at least a plurality of the magnet sensors 42, preferably TMR sensors 45, during a partial rotation, i.e., less than 360 degrees, of the crossbar 64 that occurs during a fish strike and also during each complete 360 degree rotation of the crossbar 360 that occurs during a fish strike. In a preferred embodiment where at least a plurality of spaced apart TMR sensors 45 are used, the resultant sensing arrangement is configured to be able to sense in quarter turn or 90 degree increments of rotation of the crossbar 64 during fish strike operation up to one complete rotation of the crossbar 64 as well as able to sense at least a plurality of rotations of the crossbar 64 during a fish strike.

With specific reference to FIG. 6A, in a first preferred embodiment of a sensor trigger arrangement 34b that preferably is a sensor trigger magnet arrangement 35b constructed and arranged in accordance with the present invention, each one of the magnets 38a, 38b is oriented with the same magnetic pole facing outwardly such that each one of the magnets 38a, 38b is oriented either with its north pole facing outwardly or its south pole facing outwardly. In one such embodiment, the magnets 38a, 38b are mounted to a respective one of the crossbar segments 63, 65 with the north pole of each one of the magnets 38a, 38b disposed at or adjacent a free end of the corresponding crossbar segment 63, 65 with the north pole of each one of the magnets 38a, 38b facing outwardly. In such an embodiment, the magnets 38a, 38b can be mounted to a respective one of the crossbar segments 63, 65 with the north pole of each one of the magnets 38a, 38b extending outwardly from and beyond the free end of the corresponding crossbar segment 63, 65 with the north pole of each one of the magnets 38a, 38b facing outwardly. In another such embodiment, the magnets 38a, 38b are mounted to a respective one of the crossbar segments 63, 65 with the south pole of each one of the magnets 38a, 38b disposed at or adjacent a free end of the corresponding crossbar segment 63, 65 with the south pole of each one of the magnets 38a, 38b facing outwardly. In such an embodiment, the magnets 38a, 38b can be mounted to a respective one of the crossbar segments 63, 65 with the south pole of each one of the magnets 38a, 38b extending outwardly from and beyond the free end of the corresponding crossbar segment 63, 65 with the south pole of each one of the magnets 38a, 38b facing outwardly. With continued reference to FIG. 6A, the present invention also contemplates a trigger magnet arrangement configured in accordance with that discussed above in this paragraph where the crossbar 64, and/or each one of its bar segments 63, 65, are the sensor trigger magnets and are magnetic or even magnetized so that one of the magnets 38a is formed of or integral with one of the bar segments 63 and the other one of the magnets 38b is formed of or integral with one of the bar segments 65.

With specific reference to FIG. 6B, in a second preferred embodiment of a sensor trigger arrangement 34c that preferably is a sensor trigger magnet arrangement 35c constructed and arranged in accordance with the present invention, the magnets 38a, 38b are oriented with opposite magnetic poles facing outwardly such that one of the magnets 38a, 38b is oriented with its north pole facing outwardly pole facing outwardly and the other one of the magnets 38a, 38b is oriented with its south pole facing outwardly. With continued reference to FIG. 6B, the present invention further contemplates a trigger magnet arrangement configured in accordance with that discussed in this paragraph where the crossbar 64, and/or each one of its bar segments 63, 65, are the sensor trigger magnets and are magnetic or even magnetized so that one of the magnets 38a is formed of or integral with one of the bar segments 63 and the other one of the magnets 38b is formed of or integral with one of the bar segments 65.

With specific reference to FIG. 6C, in yet a third preferred embodiment of a trigger magnet arrangement 35d, the pair of magnets 38a, 38b of the trigger magnet arrangements of FIGS. 6A & 6B are replaced with a single sensor trigger 36c that is a single elongate trigger magnet 38c that has one pole, e.g., its north (N) pole, carried by and/or disposed alongside one bar segment 63 of the crossbar 64 and its other pole, e.g., its south (S) pole, carried by and/or disposed alongside the other bar segment 65 of the crossbar 64. If desired, the length of such a single magnet 38c trigger magnet arrangement can be configured so that one end of the magnet 38c and its corresponding magnetic pole, e.g., north pole, extends outwardly beyond the free end of one of the bar segments 63 of the crossbar 64 and the opposite end of the magnet 38c and its corresponding opposite magnetic pole, e.g., south pole, extends outwardly beyond the free end of the other one of the bar segments 65 of the crossbar 64. With continued reference to FIG. 6C, the present invention further contemplates a trigger magnet arrangement configured in accordance with that discussed in this paragraph where at least one of the crossbar bar segments 63 and/or 65 and preferably the entire crossbar 64 is a single trigger magnet and is magnetic or magnetized so that it has a single north pole and a single south pole. In such a preferred crossbar trigger magnet arrangement embodiment, the entire crossbar 64 is a trigger magnet and is magnetic or magnetized with the north pole being formed of or in one of the bar segments 63 or 65 of the crossbar 64 and the south pole being formed of or in the other one of the bar segments 65 or 63 of the crossbar 64.

With specific reference to FIG. 6D, FIG. 6D illustrates a fifth preferred embodiment of a sensor trigger arrangement 34e that preferably is a fifth preferred embodiment of a sensor magnet trigger arrangement 35e that more preferably is a releasable sensor trigger magnet arrangement 85 configured for releasable engagement with at least part of the crossbar 64 of a tip up 32 that is shown in more detail in Figures ##-## and whose construction, configuration, use and operation are discussed in more detail below. The releasable sensor trigger magnet arrangement 85 includes a housing 87, such as made, e.g., molded, of plastic which contains at least one sensor trigger 36a, preferably a plurality of sensor triggers 36a, 36b axially spaced apart along the crossbar 64, more preferably at least one sensor trigger magnet 38a (or 38c), and even more preferably at least a plurality of sensor trigger magnets 38a, 38b axially spaced apart along the axial extent and/or length of the crossbar 64. As is shown in phantom in FIG. 6D, the releasable sensor trigger magnet arrangement 85 has a pair of spaced apart sensor trigger magnets 38a, 38b with one of the magnets 38a disposed at one end of the housing 87 on, along or adjacent one of the bar segments 63 of the crossbar 64 and the other one of the magnets 38b disposed at the other end of the housing 87 on, along or adjacent the other one of the bar segments 65 of the crossbar 64. If desired, the sensor trigger magnets 38a, 38b can be oriented with the same magnetic pole facing oppositely outwardly like the magnets 38a, 38b of the sensor magnet trigger arrangement 35b shown in FIG. 6A, with opposite poles of the magnets 38a, 38b facing oppositely outwardly like the magnets 38a, 38b of the sensor magnet trigger arrangement 35c shown in FIG. 6B, or a single elongate magnet like the single sensor trigger magnet 38c of the sensor magnet trigger arrangement 35d shown in FIG. 6C.

The releasable sensor trigger magnet arrangement 85 is configured for releasable mounting to at least part of the crossbar 64, such as by preferably being releasably mounted or releasably mountable to at least one of the bar segments 63 or 65 of the crossbar 64 and preferably to both of the bar segments 63 and 65 of the crossbar 64. In a preferred embodiment, the housing 87 of the releasable sensor trigger magnet arrangement 85 is configured for snap-fit engagement with part of the crossbar 64 with the housing 87 of such a preferred releasable sensor trigger magnet arrangement 85 configured for releasable snap-fit engagement with at least one and preferably both bar segments 63, 65 of the crossmember 64 such that the releasable sensor trigger magnet arrangement 85 rotates substantially in unison with the crossmember 64 during a fish strike. The housing 87 preferably is configured, e.g., molded, with at least one first channel configured with a snap fit into which at least part of the crossbar 64, such as one or both bar segments 63, 65 are received and releasably frictionally and/or snap-fittingly retained via a snap-fit or snap-fit construction. Where the housing 87 also engages part of the rod or shaft 61 of the drive shaft 62, the housing 87 is configured, e.g., molded, with at least an additional channel, preferably a second channel, configured with a snap fit into which at least part of the shaft or rod 61 of the drive shaft 62 is received and releasably frictionally and/or snap-fittingly retained via a snap-fit or snap-fit construction. In at least one preferred embodiment, the housing 87 of the releasable sensor trigger magnet arrangement 85 is configured not only to engage, preferably snap-fittingly engage, with one or both bar segments 63, 65 of the crossbar 64, but also is configured to engage with at least part of the shaft or rod 61 of the drive shaft 62 to further more securely yet releasably mount the releasable sensor trigger magnet arrangement 85 to the crossmember 64 and/or drive shaft 62 for rotation in unison therewith during a fish strike.

FIG. 7 illustrates a multi-sensor trigger arrangement 34f that preferably is a multi-magnet magnetic sensor trigger arrangement 35f employing a pair of spaced apart trigger magnets 38a, 38b arranged with their north and south magnetic poles and magnetic flux emanating therefrom and therebetween in a direction tangential to the respective bar segments 63, 65 carrying the corresponding magnets 38a, 38. In other words, each magnet 38a, 38b mounted with its north and south poles facing tangent or orthogonal to the respective crossbar bar segment 63, 65 to which the magnet 38a, 38b is mounted. While only a pair of tangentially mounted or tangentially oriented magnets 38a, 38b are used in the embodiment of FIG. 7, such a tangentially oriented multi-magnet sensor trigger arrangement can be composed of or consist of at least a plurality of pairs of, at least three, the trigger magnets with a first one of the trigger magnets 38a fixed or capping the end of a first bar or segment 63 of the spindle bar 64 extending outwardly from the drive shaft 62 in a first direction, a second one of the trigger magnets 38b fixed or capping the end of a second bar or segment 65 of the spindle bar 64 extending outwardly from the drive shaft 62 in a second direction that is opposite the direction of the first bar or segment 63, a third one of the trigger magnets (not shown) fixed or capping one end of a third bar or segment (not shown) of the spindle bar 64 extending outwardly from the drive shaft 62 in a third direction generally transverse to the first and second directions, and a fourth one of the trigger magnets (not shown) fixed or capping one end of a fourth bar or segment (not shown) of the spindle bar 64 extending outwardly from the drive shaft 62 in a fourth direction generally transverse to the first and second directions and in a direction opposite to that of the third bar or segment of the spindle bar 64.

As also discussed in more detail below, the sensor 28 onboard the sensing alarm unit 24 preferably is a magnetic sensor 42 constructed and arranged to detect at least one of (i) a magnetic field, flux, or flux density, (ii) a magnitude or strength of the magnetic field, flux or flux density, (iii) a change in magnetic field, flux, or flux density, and/or (iv) a change in the magnitude or strength of the magnetic field, flux, or flux density of a sensor trigger magnet 38 in magnetic communication therewith by being within sensing proximity thereof. Movement of a component or part of the apparatus 26 carrying one of a trigger magnet 38 and the sensing alarm unit 24 and its magnetic sensor 42 causes movement relative to the other one of the trigger magnet 38 and the sensing alarm unit 24 and its magnetic sensor 42 which in turn causes a change in one or more of (i), (ii), (iii) and/or (iv) sensed by the magnetic sensor 42 causing a user-perceptible audible and/or visual alarm to be outputted from the sensing alarm unit 24. Such a change that can be sensed by the sensor 42 is when one or more of (i), (ii), (iii) and/or (iv) falls below a predetermined threshold or threshold value, rises above a predetermined threshold or threshold value, falls outside a predetermined threshold range and/or outside of predetermined maximum and minimum threshold range values, or falls within a predetermined threshold range and/or in between predetermined maximum or minimum threshold range values indicating the occurrence of relative movement between the sensor 42 and trigger magnet 38 being sensed by the sensor 42 sufficient for the sensor 42 to signal the onboard processor (not shown) occurrence of a sensing alarm event. Of course, where the sensing alarm unit 24 is wirelessly paired with a handheld portable transportable remote alarm unit (not shown), such relative movement that triggers the sensor 42 to signal the sensing alarm unit processor of occurrence of a sensing alarm event also causes a wireless sensing alarm event message to be sent to the remotely-located portable alarm unit (not shown) causing one or more of a user-perceptible audible, visual, and/or haptic, e.g., vibratory, alarm to be generated.

As discussed in more detail below, where the apparatus 26 is a fishing apparatus 30, preferably ice fishing tip up 32, the sensor 28 of the sensing alarm unit 24 is disposed in close proximity relative to the sensor trigger arrangement 34 mounted to or carried by a component or part of the fishing apparatus 30, preferably tip up 32, and which is configured to trigger the sensor 28 upon occurrence of relative movement therebetween. With continued reference to FIGS. 1-5, the fishing apparatus 30 is an ice fishing tip up 32 of a classic or standard rail design having a generally planar or flat wooden or plastic base 44 composed of a pair of spaced apart elongate and parallel frame rails 46, 48 adjoined at opposite ends by a crossmember 50, 52 and having an elongate cylindrical tube 54, preferably drive shaft guide sleeve 53, of an elongate tip up rotary reel and drive assembly 55 pivotally attached to both rails 46, 48 enabling pivoting of the tube 54 and assembly 55 between (a) a storage position where the tip up reel and drive assembly 55 is folded until it is received in an elongate longitudinally extending reel and cylinder storage channel 56 disposed between the rails 46, 48, and (b) a T-shaped fishing operating position like that depicted in FIG. 1 where a rotary reel 58 at the end of the rod and reel assembly 55 extends downwardly through a hole in the ice of a lake or pond into the water during ice fishing operation. As is shown in FIG. 1, the storage channel 56 formed between the frame rails 46, 48 of the tip base 44 is three-dimensionally contoured to accept not only the elongate cylindrical tube 54 and drive shaft 62 but has enlarged portions disposed at opposite ends of the channel 56 to respectively accommodate the reel 58 and spindle bar 64. The reel 58 has a rotary spool 60 carrying fishing line disposed at one end of the tube 54 that is rotatively coupled by a drive shaft 62 coaxially cylindrically housed within the tube 54 to a portion of the shaft 62 extending outwardly from the tube 54 to which an elongate generally transversely extending notched spindle bar 64 is fixed for rotation in unison with the spool 60 during ice fishing tip up operation.

The tip up 32 has a fish strike indicator flag 66 that includes a flag panel or banner 68 attached to an elongate flagpole 70 anchored to the base 44 by a coil spring 72 that is a biasing element 75 that biases the flag 66 toward a generally upright fish strike indicating position but allows the flagpole 70 to be bent about the spring 70 toward a generally horizontal set or fish strike trigger position. The flag 70 is shown in FIG. 1 disposed in a generally horizontal set or trigger position by part of the flagpole 70 being releasably retained in the generally horizontal set or trigger position by the notched spindle bar 64 by being disposed underneath the bar 64 and retained in a notch in the bar 64. When a fish strikes bait attached to fishing line and runs with the bait, it unspools fishing line from the spool 60 rotating the drive shaft 62 which turns the spindle bar 64 until the bar 64 disengages from the flagpole 70 thereby releasing the flagpole 70. Once the flagpole 70 is released, the flagpole biasing spring 72 quickly urges the flagpole 70 uprightly rotating the flagpole 70 upwardly about the tip up base 44 from the generally horizontal set or trigger position shown in FIGS. 1-4 (where the flagpole 70 is generally parallel to the tip up base 44) to a fish strike indicator position where the flagpole 70 is generally vertical (where the flagpole 70 is generally perpendicular or orthogonal to the tip up base 44). When disposed in the generally upright fish strike indicator position, the banner 68 of the flag 66 is readily visible for a user of the tip up 32, i.e., fisherman, to see signaling the fisherman to come check the tip up 32 and reel in the fish that has taken the bait.

A first sensing alarm unit embodiment is shown in FIGS. 1-4 where the sensing alarm unit 24 is adapted for use with an ice fishing tip up 32, the sensing alarm unit 24 is configured for releasable but secure mounting to the flagpole 70 adjacent the flagpole anchor spring 72 and the sensor trigger arrangement 34 that is a single permanent magnet 40 immovably fixed to an upper or outer surface 74 of the tip up base 44 adjacent the spring 72. The sensing alarm unit 24 preferably is removably attached to the flagpole 70 by a mount 76, which is removably attached to one end of the housing 78 of the unit 24 with a clamp 80 with a pair of clamp jaws 82, 84 that releasably clamps around the flagpole 70 enabling the unit 24 to be slidably selectively positioned anywhere along the flagpole 70. A fastener 73, preferably a thumbscrew 75, is disposed in operable cooperation with the jaws 82, 84 of the clamp 80 of the mount 76 and configured for manual rotation of the fastener 73, preferably thumbscrew 75, (a) in one direction, e.g., clockwise, to decrease the space between the jaws 82, 84, clamp the jaws 82, 84 together around the flagpole 70, and/or increase the clamping force exerted by the jaws 82, 84 against the flagpole 70 to releasably mount the alarm unit 24 to the flagpole 70, and (b) in an opposite direction, e.g., counterclockwise, to decrease the clamping force exerted by the jaws 82, 84 against the flagpole 70, increase the space between the jaws 82, 84, and/or move one or both jaws 82, 84 away from the flagpole 70, disengage, release and/or unclamp the jaws 82, 84 from the flagpole 70 thereby unclamping the clamp 80 from the flagpole 70 enabling the alarm unit 24 to be detached from the flagpole 70 and removed from the tip-up 32. The sensing alarm unit 24 preferably is equipped with at least one and preferably at least a plurality of an accelerometer, preferably at least a 3-axis accelerometer, gyro, preferably at least at a 3-axis gyro, angular rate sensor, magnetometer, preferably a 3-axis magnetometer, Inertial Measurement Unit (IMU) sensor, Heading Reference Unit (HRU) sensor, tilt sensor, inclinometer and/or a combination of two or more of these sensors configured, including in firmware and/or software, to detect sensing alarm unit motion relative to the tip up, preferably detect movement, including linear and/or angular motion, acceleration and/or jerk of the sensing alarm unit relative to the tip up during movement of the flagpole from its generally horizontal armed position to the generally vertical fish strike indicating position during a fish strike during tip up fishing operation.

The sensing alarm unit 24 is removably mounted by the mount 76 to a portion of the flagpole 70 adjacent the spring 72 with the magnetic sensor 42 of the alarm unit 24 positioned in relatively close proximity to the magnet 40, preferably generally overlying the magnet 40, when the flagpole 70 is disposed in the generally horizontal set or fish strike trigger position with the flagpole 70 releasably engaged with the spindle bar 64. When the alarm unit 24 is releasably mounted to the flagpole 70 the mount 76, including its clamp 80, is disposed at an end of the alarm unit 24 and housing 78 that is positioned distal to the tip up flagpole spring 72 as depicted in FIGS. 1-4. The sensing alarm unit 24 is releasably mounted to the flagpole 70 above and adjacent to the spring 72 to minimize angular acceleration imparted to the sensing alarm unit 24 when the generally horizontally oriented flagpole 70 disengages from the spindle bar 64 and whips vertically upon occurrence of a fish strike.

In another preferred embodiment, the sensing alarm unit 24 is removably mounted to one of the shaft or rod 61 of the drive shaft 62 and/or one or both bar segments 63, 65 of the spindle bar or crossbar 64 for rotation substantially in unison therewith during a fish strike. The sensing alarm unit 24 preferably is equipped with at least one and preferably at least a plurality of an accelerometer, preferably at least a 3-axis accelerometer, gyro, preferably at least at a 3-axis gyro, angular rate sensor, magnetometer, preferably a 3-axis magnetometer, Inertial Measurement Unit (IMU) sensor, Heading Reference Unit (HRU) sensor, tilt sensor, inclinometer and/or a combination of two or more of these sensors configured, including in firmware and/or software, to detect sensing alarm unit motion relative to the tip up, preferably detect rotation of the sensing alarm unit relative to the tip up, during rotation of the drive shaft and/or spindle bar or crossbar during a fish strike during tip up fishing operation.

Although not shown in the drawings, a pair of mounts 76 can be used with one of the mounts 76 removably attached such as preferably via twist-lock engagement to one end of the housing 78 of the sensing alarm unit 24 and another one of the mounts 76 removably attached, such as preferably via twist-lock engagement, to the opposite end of a housing 78 of the sensing alarm unit 24. The clamp 80 of both mounts 76 clip or clamp onto a corresponding portion or segment of the flagpole 70 at two different apart locations along the flagpole 70 thereby more securely releasably mounting the sensing alarm unit 24 to the fish strike indicator flag 66 of the tip up 32. If desired, a side of the housing 78 of the sensing alarm unit 24 can have a recessed channel or recessed groove formed in its outer surface for receiving the section of the flagpole 70 of the fish strike indicator flag 66 extending adjacent to and alongside the sensing alarm unit 24 between the two spaced apart clamps 80 of the two spaced apart mounts 76.

The magnet 40 can be a rare earth magnet that is annular, circular, cylindrical or disc-shaped which preferably oriented relative to the tip up 32 with one of its magnetic poles, e.g., north pole, facing upwardly away from the tip up base 44 and the other one of its magnetic poles, e.g., south pole, facing downwardly towards the base 44. The magnet 40 is adhesively attached to the base 44 and/or fixed by one or more fasteners to the base 44 but can be attached to the base 44, including removably attached, in another manner if desired. For example, the magnet 40 can also be recessed into, countersunk in, embedded inside, or even encapsulated within the tip up base 44.

The magnet 40 outputs or emits a steady-state source of magnetic and is mounted to the tip up base 44 adjacent the flagpole spring 72 positioned close enough to the magnetic sensor 42 of the sensing alarm unit 24 mounted to the flagpole 70 to be sensed by the magnetic sensor 42 when the flagpole 72 is releasably engaged with the spindle bar 64 in the generally horizontal set or fish strike indicator trigger position shown in FIGS. 1-4. The magnet 40 is mounted on the crossmember 50 of the tip up base 44 to which the flagpole anchor spring 72 is attached and positioned close enough to the magnetic sensor 42 of the sensing alarm unit 24 so as to underlie the sensor 42 such that, when the generally horizontally oriented flagpole 70 disengages from the spindle bar 64 due to spindle bar rotation caused by a fish striking the bait, the sensor alarm unit 24 moves substantially in unison with the flagpole 70 as that flagpole 70 springs upwardly away from the magnet 40 towards the generally vertical fish-strike signaling position.

As previously noted, the sensing alarm unit 24 is configured to be selectively positioned or selectively positionable along the flagpole 70 to which it is releasably mounted to position its onboard magnet sensor 42 in close enough proximity to the magnet 40 of the sensor trigger arrangement 34 fixed to the tip up base 44 to detect relative movement therebetween in a direction away from the magnet 40 when a fish strike disengages the flagpole 70 from the spindle bar 64. When the flagpole 70 is in the set or trigger position, the magnetic sensor 42 and sensing alarm unit 24 overlies the magnet 40 and is disposed in close enough proximity thereto such that the magnetic field, flux or flux density of the magnet 40 reaching the magnetic sensor 42 is greater than a predetermined threshold field strength, flux, or flux density preventing the sensor 42 from triggering the sensor alarm unit 24 to alarm and/or transmit a wireless alarm message to a portable alarm unit (not shown) located remote therefrom.

When a fish strikes and causes the tip up flagpole 70 to disengage from the rotating spindle bar 64, the strength of the magnetic field, magnetic flux and/or magnetic flux density reduces as the magnetic sensor 42 and sensing alarm unit 24 move in unison with the flagpole 70 vertically away from the magnet 40 and tip up base 44 until it falls below a threshold magnetic field strength, flux or flux density of the magnetic sensor 42 which causes the sensor 42 to trigger the sensor alarm unit 24 to issue a fish strike indicator alarm and preferably also transmit a wireless fish strike indicator alarm message to a portable alarm unit (not shown) located remote therefrom.

Occurrence of such a fish strike indicator sensor alarm event causes the sensing alarm unit 24 to activate and/or energize one and preferably both of (a) a light, which can be in the form of a light bright enough to be seen for at least 1000 yards, such as a bright flashing strobe, a bright LED light or lamp, or other type of light source, and/or (b) an audio transducer, such as in the form of a loudspeaker, piezoelectric sound transducer, or other type of sound emitting transducer to provide a fish strike alarm that is both visually and audibly perceptible to a user of the tip up who is a fisherman. Occurrence of such a fish strike sensor alarm event also causes the sensing alarm unit to wirelessly transmit a fish strike sensor alarm event message to a remotely-located user transportable handheld alarm unit or controller (not shown) thereby causing the handheld portable alarm unit or controller to activate and/or energize at least one and preferably at least a plurality of (a) a light, such as one or more LEDs, (b) an alarm sound-outputting audio transducer, such as a speaker and/or piezoelectric transducer or actuator, and/or (c) an alarm vibration outputting haptic actuator, such as one or more of a linear resonant actuator (LRA), eccentric rotating mass actuator (ERM), and/or a piezoelectric actuator to provide at least one different type and preferably at least a plurality of different types of fish strike alarm(s) to the user, preferably a fisherman, remotely monitoring operation of the tip up 32.

As the sensing alarm unit 24 and flagpole 70 move in unison upwardly away from the set or trigger position after occurrence of a fish strike, the sensing alarm unit 24 moves away from the magnet 40 fixed to the tip up base 44 causing the magnetic sensor 42 to open or close, depending on its configuration, and signal the processor (not shown) onboard the sensing alarm unit 24 of the occurrence of a sensing event that is a fish strike sensing alarm event. As the magnetic sensor 42 moves in unison with the sensing alarm unit 24 and flagpole 70 away from the magnet 40, the magnetic field strength, magnetic flux, or magnetic flux density of the magnet 40 decreases until it drops below a predetermined flux threshold or predetermined flux density threshold that triggers the magnetic sensor 42 to open or close and signal the onboard processor (not shown) of the occurrence of a fish strike sensing alarm event. To facilitate such suitably sensitive sensing of the change in flux or flux density of the magnet 40, preferably the decrease in flux or flux density thereof, which occurs during relative movement between the magnetic sensor 42 and magnet 40 caused by them separating from one another during fish-strike indicating flagpole movement, the magnetic sensor 42 preferably is a magnetoresistance or magneto-resistive magnetic sensor, more preferably a TMR sensor 45, and the magnet 40 preferably is mounted to the frame or base 44 of the tip up with one of its poles, such as its north pole or south pole, facing toward the TMR magnetic sensor 45 and sensing alarm unit 24.

Once such a sensing event occurs that is a fish strike sensing alarm event triggered by the magnet 40 triggering the TMR magnetic sensor 45 of the sensing alarm unit 24 mounted to the tip up flagpole 70, the onboard processor (not shown) of the sensing alarm unit 24 is configured in firmware and/or software to provide a human perceptible alarm in the form of a light or strobe onboard the sensing alarm unit 24 that is energized by the processor of the sensing alarm unit 24. Such a sensing alarm unit 24 adapted for tip up fishing apparatus use is further configured in firmware and/or software to wirelessly send a wireless sensing event message that is a fish strike indicator sensing alarm event message to a hand-held manually operable portable transportable user alarm unit or controller (not shared) paired therewith thereby causing the portable handheld user alarm unit or controller (not shown) to output a human perceptible alarm in the form of one or more of an audible tone, energize one or more lights, e.g., LED(S), and/or output a haptic alarm, such as in the form of a vibratory alarm that vibrates the user alarm unit or controller. Because the sensing alarm unit 24 and portable handheld user alarm unit or controller (not shown) are configured for wireless communication, preferably bidirectional wireless communication, therebetween over distances of at least one half mile, preferably at least one mile, and more preferably at least one and a half miles, the portable handheld user alarm unit or controller (not shown) is configured to provide at least a plurality, preferably a plurality of pairs of the audible, light and haptic alarms substantially simultaneously upon receiving a wireless fish strike indicator sensing event message from the sensing alarm unit 24.

To rearm the tip up 32 and the sensing alarm unit 24 after occurrence of a fish strike, the tip up flagpole 70 carrying the sensing alarm unit 24 is reengaged with the spindle bar 64 by bending the flagpole 70 about the coil spring 72 until the flagpole 70 is generally horizontal and received in a notch in the underside of the spindle bar 64. When the flagpole 70 is engaged with the spindle bar 64, the magnetic flux or flux density of the magnetic field lines of the magnet 40 are sensed by the TMR magnetic sensor 45 thereby resetting and/or rearming the sensing alarm unit 24 readying the sensing alarm unit 24 to sense another magnetically triggered fish strike sensing alarm event. In a preferred embodiment, the sensing alarm unit 24 and/or portable transportable handheld user alarm unit or controller (not shown) can be configured so that a control, setting or input onboard one or both the sensing alarm unit 24 and portable handheld alarm unit or controller (not shown) is manipulated or manually operated when the TMR magnet sensor 45 of the sensing alarm unit 24 when flagpole 70 of the tip up 32 is returned to the generally horizontal fish strike detecting or triggering position thereby resetting the sensing alarm unit 24 so it will output a fish strike indicating sensing event message upon the occurrence of the next fish strike.

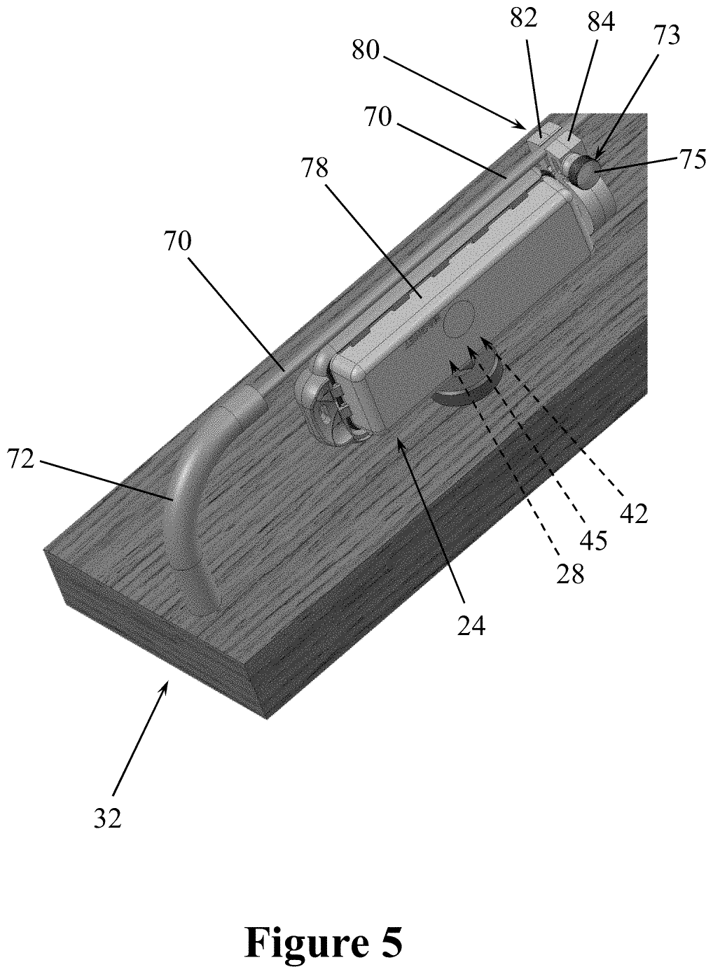

In a second preferred system, sensing alarm unit, and sensor trigger arrangement embodiment and configuration depicted in FIG. 5, the sensor alarm unit 24 also is configured for operation with a piece of outdoor equipment 26, e.g., outdoor recreation equipment, which preferably is a fishing apparatus 30 that more preferably is an ice fishing tip up 32. The second preferred embodiment and configuration also is well suited for use with a tip up 32 like that described above that is equipped with a base 44, e.g., frame, which supports the tip up 32 on the generally horizontally extending ice of a body of water being fished therewith. The sensor trigger arrangement 34 is attached to a movable component of the tip up 32 for movement in unison with movement of the movable component of the tip up 32 and the sensing alarm unit 24 is removably mounted by the mount 76 to the base or frame 44 of the tip up 32 with its onboard sensor 28 disposed adjacent to and in close enough proximity to the sensor trigger arrangement 34 to sense movement of the sensor trigger arrangement 34 relative to the sensor 28 caused by movement of the movable component of the tip up 32 and trigger the sensing alarm unit 24 into issuing an alarm.

In a preferred implementation of the second embodiment and configuration, the sensor trigger arrangement 34 is carried by the spindle bar 64 and operably coupled thereto preferably by being fixed thereto such that sensor trigger arrangement 34 rotates in unison with the spindle bar 64, the drive shaft 62 and the spool 60 of the reel 58 during ice fishing tip up use and operation. The sensor alarm unit 24 is releasably attached to the base or frame 44 of the tip up 32 by the mount 76 bin a manner that positions the sensor 28 adjacent to and in close enough proximity to the sensor trigger arrangement 34 for the sensor 28 to detect rotational movement of the sensor trigger arrangement 34 relative to the sensor 28 caused when a fish takes and runs with bait attached to fishing line carried by the spool 60 of the tip up reel 58 thereby unspooling line from the spool 60. Unspooling of fishing line from the spool 60 rotates the spool 60 which in turn rotates the drive shaft 62 and spindle bar 64, which disengages and releases the flagpole 70 causing the flagpole 70 to spring uprightly from the generally horizontal fish strike indicator trigger position to the generally vertical fish strike indicator position.

As shown in FIG. 5, the sensor trigger arrangement 34 has a plurality of sensor triggers 36a, 36b each configured to trigger the sensing alarm unit sensor 28 with one of the sensor triggers 36a carried by or mounted on one segment or branch 63 of the spindle bar 64 that extends transversely to the drive shaft 62 and support tube 54 in one direction and another one of the sensor triggers 36b carried by or mounted on the other segment or branch 65 of the spindle bar 64 that extends transversely to the drive shaft 62 and support tube 54 in the opposite direction. In preferred configuration, the processor (not shown) and/or sensor 28 onboard the sensing alarm unit 24 is or are configured, such as in software and/or firmware, to output at least one of an audible and/or visible alarm upon one of the sensor triggers 36a, 36b triggering the sensor 28 when its rotational movement causes one of the sensor triggers 36a or 36b to pass by the sensor 28 and through a sensing field 47 of the sensor 28 the first time causing the sensor 28 to trigger the sensing alarm unit 24 into issuing an audible and/or visible fish strike indicator alarm. In one such sensing alarm unit configuration, the onboard processor (not shown) and/or sensor 28 is or are configured in software and/or firmware to output at least one of an audible and/or visible fish strike indicator alarm upon the first pass of both sensor triggers 36a, 36b sequentially passing by the sensor 28 during the first rotation, e.g., first complete 3600 rotation, of the spindle bar 64, drive shaft 62, and spool 60 upon occurrence of a fish strike where a fish has taken and run with bait. When one of the sensor triggers 36a first passes by and/or across the sensor 28 or all of the sensor triggers 36a, 36b sequentially pass by and across the sensor 28 indicating that a first complete revolution of the spindle bar 64, drive shaft 62 and spool 60 has occurred, the sensing alarm unit 24 can be configured to issue or output a fish strike indicator alarm composed of one or both of an audible alarm and/or a visible alarm substantially simultaneously and/or sequentially, including with respect to a predetermined fish strike indicator alarm sequence implemented in accordance with one or more of the fish strike indicator alarm configuration(s) described in detail above for the first embodiment and configuration.

The sensing alarm unit 24 preferably is further configured to transmit a wireless fish strike alarm message to wirelessly paired remotely located portable handheld alarm unit (not shown) causing the portable alarm unit to issue fish strike indicator alarm composed of one or more of an audible alarm, a visible alarm, and/or a vibratory haptic alarm outputted substantially simultaneously and/or sequentially therefrom, including in a predetermined fish strike indicator alarm sequence. If desired, the portable alarm unit (not shown) can be configured to issue or output a fish strike alarm the same as or similar to that outputted by the portable alarm unit of the first embodiment and configuration described in detail above.

In a first preferred implementation of the second embodiment and configuration, the onboard processor (not shown) and/or sensor 28 is or are configured in software and/or firmware to brightly flash a visual alarm, preferably by energizing a light, such as an LED, onboard the sensing alarm unit 24 a single time upon one of (a) sensor detection of movement of one of the sensor triggers 36a, 36b of the sensor trigger arrangement 34 passing by the sensor 28 and/or through the sensing field extending in front of the sensor 28 a single time during initial fish strike rotational movement of the sensor trigger arrangement 34 being first rotated by the spindle bar 64 in response to a fish striking the bait causing fishing line to unspool from the spool 60 and begin rotation of the spool 60, (b) sensor detection of movement of all of the sensor triggers 36a, 36b of the sensor trigger arrangement 34 sequentially passing by the sensor 28 and/or passing through a sensing field of the sensor 28 extending outwardly from the sensor 28 a single time during the first complete revolution, preferably 360° rotation, of the sensor trigger arrangement 34, spindle bar 64, drive shaft 62 and spool 60 in response to a fish striking the bait causing fishing line to unspool and rotate the spool 600 a first complete revolution, preferably 360° rotation, or (c) sensor detection of movement of all of the sensor triggers 36a, 36b sequentially passing by the sensor 28 and/or passing through a sensing field of the sensor 28 a first time and the first one of the sensor triggers 36a that passed by the sensor 28 and/or through the sensing field of the sensor 28 a first time thereafter passing by the sensor 28 and/or through the sensing field of the sensor 28 a second time in completing the first revolution, preferably 360° rotation, of the sensor trigger arrangement 34, spindle bar 64, drive shaft 62 and spool 60 in response to a fish striking the bait causing fishing line to unspool and rotate the spool 60 a first complete revolution, preferably 360° rotation. Where wirelessly paired with a remotely located transportable handheld portable alarm unit (not shown), the processor (not shown) onboard the sensing alarm unit 24 is configured in software and/or firmware to send one or more corresponding wireless alarm event message(s) to the remotely located portable alarm unit (not shown) whose onboard processor is configured in software and/or firmware to flash a visual alarm, preferably by energizing a light, such as an LED, onboard the portable alarm unit a single time and/or at least briefly activate a vibratory alarm, such as by energizing a vibrating transducer onboard the portable alarm unit to vibrationally “pulse” a single time upon occurrence of fish strike indicating rotational movement of one or more or all of the sensor triggers 36a, 36b of the sensor trigger arrangement 34, the sensor trigger arrangement 34, spindle bar 64, drive shaft 62, and spool 60 of the tip up 32 in accordance with that defined in at least one of (a), (b) or (c) set forth above in the preceding sentence.

In such a first preferred implementation, the onboard processor and/or sensor 28 is or are configured in software or firmware to briefly output a relatively loud audible alarm, preferably in the form of a sound, such as a “beep,” “click,” or “chirp,” from an audio transducer, e.g., speaker or piezoelectric audio transducer, onboard the sensing alarm unit 24 upon or after each revolution, preferably each complete revolution, i.e., each 360° rotation, of the sensor trigger arrangement 34, spindle bar 64, drive shaft 62 and spool 60 caused by continued unspooling of fishing line by a fish who has taken bait attached to the line and run with it. Where wirelessly paired with a portable alarm unit (not shown), the processor onboard the sensing alarm unit 24 is further configured in software and/or firmware to send one or more corresponding wireless alarm event message(s) to the portable alarm unit (not shown) whose onboard processor is further configured in software and/or firmware to substantially simultaneously also briefly output an audible alarm, preferably in the form of a sound, such as a “beep,” “click,” or “chirp,” from an audio transducer, e.g., speaker or piezoelectric audio transducer, onboard the portable alarm unit upon or after the occurrence of each revolution, preferably each complete revolution, i.e., each 360° rotation, of the sensor trigger arrangement 34, spindle bar 64, drive shaft 62 and spool 60 sensed by the sensor 28 onboard the sensing alarm unit 24. The portable alarm unit processor can be still further configured to also pulse the onboard vibratory alarm or vibratory transducer a single time upon or after the occurrence of each revolution, preferably each complete revolution, i.e., each 360° rotation, of the sensor trigger arrangement, spindle bar, drive shaft and spool 60 sensed by the sensor onboard the sensing alarm unit.

In one embodiment of the first preferred implementation, the processor and/or sensor 28 is or are configured in software and/or firmware to brightly flash the onboard visual alarm, preferably by energizing a light, such as an LED, onboard the sensing alarm unit 24 upon or after the occurrence of a predetermined number of sensor sensed revolutions or rotations of the sensor trigger arrangement 34, spindle bar 64, drive shaft and spool as a result of continued rotation of the spool 60 from a fish that took the bait continuing to unspool line therefrom. Where wirelessly paired with a portable alarm unit, the portable alarm unit processor is further configured in software and/or firmware to substantially simultaneously also briefly output a visible alarm by flashing an onboard light, e.g., LED, upon or after the sensing of the predetermined number of revolutions or rotations of the sensor trigger arrangement, spindle bar, drive shaft 62 and spool 60 by the sensor 28 onboard the sensing alarm unit 24. The portable alarm unit processor can be still further configured cause the onboard vibratory alarm or vibratory transducer to issue a pulse pattern different than when the first rotation or revolution occurs upon or after the sensing of the predetermined number of revolutions or rotations of the sensor trigger arrangement 34, spindle bar 64, drive shaft 62 and spool 60 by the sensor onboard the sensing alarm unit 24.

In one such embodiment, the processor and/or sensor is or are configured in software or firmware to brightly flash the onboard visual alarm, preferably by flashing a light, such as an LED, upon or after the occurrence of every five revolutions of the sensor trigger arrangement, spindle bar, drive shaft and spool as a result of a fish taking the bait and unspooling enough fishing line to rotate the spool at least five revolutions or rotations. Where wirelessly paired with a portable alarm unit, the portable alarm unit processor is further configured in software and/or firmware to substantially simultaneously also briefly output a visible alarm by flashing an onboard light, e.g., LED, upon or after every five revolutions or rotations of the sensor trigger arrangement 34, spindle bar 64, drive shaft 62 and spool 60 sensed by the sensor onboard the sensing alarm unit 24. The portable alarm unit processor can be still further configured cause the onboard vibratory alarm or vibratory transducer to issue a pulse pattern different than when the first rotation or revolution occurs and different than when each subsequent rotation or revolution occurs upon or after every five revolutions or rotations of the sensor trigger arrangement 34, spindle bar 64, drive shaft 62 and spool 60 sensed by the sensor onboard the sensing alarm unit 24.

In another such embodiment, the processor and/or sensor is or are configured in software or firmware to brightly flash the onboard visual alarm, preferably by flashing a light, such as an LED, upon or after the occurrence of every ten revolutions of the sensor trigger arrangement 34, spindle bar 64, drive shaft 62 and spool 60 as a result of a fish taking the bait and unspooling enough fishing line to rotate the spool at least ten revolutions or rotations. Where wirelessly paired with a portable alarm unit, the portable alarm unit processor is further configured in software and/or firmware to substantially simultaneously also briefly output a visible alarm by flashing an onboard light, e.g., LED, upon or after every ten revolutions or rotations of the sensor trigger arrangement 34, spindle bar 64, drive shaft 62 and spool 60 sensed by the sensor onboard the sensing alarm unit 24. The portable alarm unit processor can be still further configured cause the onboard vibratory alarm or vibratory transducer to issue a pulse pattern different than when the first rotation or revolution occurs and different than when each subsequent rotation or revolution occurs upon or after every ten revolutions or rotations of the sensor trigger arrangement 34, spindle bar 64, drive shaft 62 and spool 60 sensed by the sensor onboard the sensing alarm unit 24

In a second preferred implementation of the second embodiment and configuration, the onboard processor and/or sensor 28 of the sensing alarm unit 24 is configured in software and/or firmware to loudly emit an audible alarm, such as by energizing an audio transducer, e.g., loudspeaker, onboard the sensing alarm unit 24 to output a “beep,” “click,” or “chirp a single time upon one of (a) sensor detection of movement of one of the sensor triggers 36a, 36b of the sensor trigger arrangement 34 passing by the sensor 28 and/or through the sensing field of the sensor 28 a single time during initial fish strike rotational movement of the sensor trigger arrangement being first rotated by the spindle bar in response to a fish striking the bait causing fishing line to unspool and begin rotation of the spool of the tip up reel, (b) sensor detection of movement of all of the sensor triggers each passing by the sensor 28 and/or passing through a sensing field of the sensor 28 a single time during the first complete revolution, preferably 360° rotation, of the sensor trigger arrangement 34, spindle bar 64, drive shaft 62 and spool 60 in response to a fish striking the bait causing fishing line to unspool and rotate the spool a first complete revolution, preferably 360° rotation, or (c) sensor detection of movement of all of the sensor triggers each passing by the sensor 28 and/or passing through a sensing field of the sensor 28 a first time and the first one of the sensor triggers that passed by the sensor 28 and/or through the sensing field of the sensor 28 passing by the sensor 28 and/or through the sensing field of the sensor 28 a second time during the first complete revolution, preferably 360° rotation, of the sensor trigger arrangement 34, spindle bar 64, drive shaft 62 and spool 60 in response to a fish striking the bait causing fishing line to unspool and rotate the spool a first complete revolution, preferably 360° rotation. Where wirelessly paired with a remotely located portable alarm unit, the processor onboard the sensing alarm unit 24 is configured in software and/or firmware to send one or more corresponding wireless alarm event message(s) to the portable alarm unit whose onboard processor is configured in software and/or firmware to substantially simultaneously briefly emit an audible alarm, such from an audio transducer, e.g., speaker, in the form of a “beep,” “click,” or “chirp,” a single time and/or briefly activate a vibratory alarm, such as by energizing a vibrating transducer onboard the portable alarm unit to vibrationally “pulse” a single time upon occurrence of fish strike indicating rotational movement of one or more or all of the sensor triggers of the sensor trigger arrangement, the sensor trigger arrangement, spindle bar, drive shaft, and spool of the tip up reel in accordance with that defined in at least one of (a), (b) or (c) set forth above in the preceding sentence.

In the second preferred implementation, the onboard processor and/or sensor 28 is or are configured in software or firmware to briefly output a relatively bright visible alarm, such as by flashing a light that preferably is an LED onboard the sensing alarm unit 24 upon or after each revolution, preferably each complete revolution, i.e., each 360° rotation, of the sensor trigger arrangement 34, spindle bar 64, drive shaft 62 and spool 60 caused by continued unspooling of fishing line by a fish who has taken bait attached to the line and run with it. Where wirelessly paired with a portable alarm unit, the processor onboard the sensing alarm unit 24 is further configured in software and/or firmware to send one or more corresponding wireless alarm event message(s) to the portable alarm unit whose onboard processor is further configured in software and/or firmware to substantially simultaneously also briefly output a visible alarm by flashing a light that preferably is an LED onboard the portable alarm unit upon or after the occurrence of each revolution, preferably each complete revolution, i.e., each 360° rotation, of the sensor trigger arrangement 34, spindle bar 64, drive shaft 62 and spool 60 sensed by the sensor 28 onboard the sensing alarm unit 24. The portable alarm unit processor can be still further configured to also pulse the onboard vibratory alarm or vibratory transducer a single time upon or after the occurrence of each revolution, preferably each complete revolution, i.e., each 360° rotation, of the sensor trigger arrangement 34, spindle bar 64, drive shaft 62 and spool 60 sensed by the sensor 28 onboard the sensing alarm unit 24. The pulse outputted preferably has a pulse pattern or utilizes a sequence of short pulses different than the single pulse issued by the vibratory alarm, e.g., vibratory transducer, onboard the portable alarm unit upon initial sensing of a fish strike by the sensor 28 onboard the sensing alarm unit 24.

In one embodiment of the first preferred implementation, the processor and/or sensor 28 is or are configured in software and/or firmware to relatively loudly emit an audible alarm, preferably using an onboard audio transducer, such as a speaker, that emits a “beep,” “click,” or “chirp” a upon or after the occurrence of a predetermined number of sensor 28 sensed revolutions or rotations of the sensor trigger arrangement 34, spindle bar 64, drive shaft 62 and spool 60 as a result of continued rotation of the spool from a fish that took the bait continuing to unspool line therefrom. Where wirelessly paired with a portable alarm unit, the portable alarm unit processor is further configured in software and/or firmware to substantially simultaneously also briefly output an audible alarm by emitting a “beep,” “click,” or “chirp” from an audio transducer, e.g., speaker, onboard the portable alarm unit upon or after the sensing of the predetermined number of revolutions or rotations of the sensor trigger arrangement 34, spindle bar 64, drive shaft 62 and spool 60 by the sensor 28 onboard the sensing alarm unit 24. The portable alarm unit processor can be still further configured cause the onboard vibratory alarm or vibratory transducer to issue a pulse pattern different than when the first rotation or revolution and when each subsequent rotation or revolution occurs upon or after occurrence of the predetermined number of revolutions or rotations of the sensor trigger arrangement 34, spindle bar 64, drive shaft 62 and spool 60 as sensed by the sensor 28 onboard the sensing alarm unit 24.

In one such embodiment, the processor and/or sensor 28 is or are configured in software or firmware to loudly emit an audible alarm, such as in the form of a “beep,” “click,” or “chirp” emitted from an onboard audio transducer, outputted upon or after the occurrence of every five revolutions or rotations of the sensor trigger arrangement 34, spindle bar 64, drive shaft 62 and spool 60 as a result of a fish taking the bait and unspooling enough fishing line to rotate the spool at least five revolutions or rotations. Where wirelessly paired with a portable alarm unit, the portable alarm unit processor is further configured in software and/or firmware to substantially simultaneously also briefly output an audible alarm in the form of a beep,” “click,” or “chirp” emitted by an onboard audio transducer upon or after every five revolutions or rotations of the sensor trigger arrangement 34, spindle bar 64, drive shaft 62 and spool 60 sensed by the sensor onboard the sensing alarm unit 24. The portable alarm unit processor can be still further configured cause the onboard vibratory alarm or vibratory transducer to issue a pulse pattern different than when the first rotation or revolution occurs and different than when each subsequent rotation or revolutions occurs upon or after every five revolutions or rotations of the sensor trigger arrangement 34, spindle bar 64, drive shaft 62 and spool 60 sensed by the sensor 28 onboard the sensing alarm unit 24.

In another such embodiment, the processor and/or sensor 28 is or are configured in software or firmware to loudly emit an audible alarm, such as in the form of a “beep,” “click,” or “chirp” from an onboard audio transducer, outputted upon or after the occurrence of every ten revolutions of the sensor trigger arrangement 34, spindle bar 64, drive shaft 62 and spool 60 as a result of a fish taking the bait and unspooling enough fishing line to rotate the spool at least ten revolutions or rotations. Where wirelessly paired with a portable alarm unit, the portable alarm unit processor is further configured in software and/or firmware to substantially simultaneously also briefly output an audible alarm in the form of a beep,” “click,” or “chirp” emitted by an onboard audio transducer upon or after every ten revolutions or rotations of the sensor trigger arrangement 34, spindle bar 64, drive shaft 62 and spool 60 sensed by the sensor 28 onboard the sensing alarm unit 24. The portable alarm unit processor can be still further configured cause the onboard vibratory alarm or vibratory transducer to issue a pulse pattern different than when the first rotation or revolution occurs and different than when each subsequent rotation or revolutions occurs upon or after every ten revolutions or rotations of the sensor trigger arrangement 34, spindle bar 64, drive shaft 62 and spool 60 sensed by the sensor 28 onboard the sensing alarm unit 24.

In the second preferred system, sensing alarm unit 24, and sensor trigger arrangement embodiment and configuration, the sensor trigger arrangement 34 includes at least a plurality of sensor triggers that are preferably disposed along a common plane and angularly spaced apart so as to oppositely facing or opposed to one another when the sensor trigger arrangement 34 is carried by and preferably mounted to the spindle bar of the tip up fishing apparatus in a manner such that rotation of the spool rotates the drive shaft, the spindle bar, and the sensor triggers of sensor trigger arrangement 34 in unison during fish strike and fish bait taking operation of the tip up fishing apparatus. In one sensor trigger arrangement embodiment, the sensor trigger arrangement 34 is composed of and can consist of a plurality, preferably a pair, of spaced apart sensor triggers with one of the sensor triggers carried by and preferably fixed to one segment or section of a cross-beam of the spindle bar that extends transversely relative to and outwardly from the drive shaft in one direction and the other one of the sensor triggers in turn carried by and preferably fixed to the other segment or section of the cross-beam of the spindle bar that extends transversely relative to and outwardly from the drive shaft in in the opposite direction. Each sensor trigger preferably is carried by or mounted to a respective end of a corresponding one of the sections or segments of the cross-beam of the spindle bar so as to locate each sensor trigger as far out on the respective cross-beam segment or section end in order to position the sensor trigger in close enough proximity to the sensor 28 of the sensor alarm unit to be sensed by the sensor 28 as each sensor trigger respectively passes through a sensing field extending outwardly of or from the sensor 28 toward the sensor trigger as the sensor trigger passes by the sensor 28 during rotation of the spindle bar and the sensor triggers fixed thereto during unspooling of fishing line from the spool of the reel of the tip up fishing apparatus when a fish strikes and takes the bait.

In one embodiment, a single revolution or rotation of the sensor trigger arrangement 34 composed of a pair of oppositely outwardly facing or disposed sensor triggers respectively fixed to oppositely outwardly extending segments or sections of the cross-bar of the spindle bar is detected when the sensing alarm unit sensor senses one of (a) each one of the pair of the sensor triggers passing by the sensor 28 during spindle bar rotation driven by unspooling of fishing line from the spool of the ice fishing apparatus tip up reel, or (b) each one of the pair of the sensor triggers passing by the sensor 28 once and the first one of the pair of sensor triggers passing by the sensor 28 a second time. In another preferred sensor trigger embodiment, the sensor trigger embodiment is composed of or consists of at least a plurality of pairs of, i.e., at least three, sensor triggers carried by or mounted to the spindle bar that are equiangularly spaced apart from one another and arranged to rotate substantially in unison with the spindle bar in or along a common plane disposed generally in line with the sensing alarm unit sensor 28 disposed adjacent to and preferably alongside the spindle bar. In one such preferred sensor trigger embodiment, the sensor trigger arrangement 34 is composed of or consists of four, five, six, seven, eight or even more of the sensor triggers carried by or fixed to the spindle bar each disposed at or along a radially outermost end of part of the spindle bar or a sensor trigger arrangement 34 carrying the sensor triggers mounted to the spindle bar which are equiangularly spaced apart from one another and preferably have adjacent sensor triggers equidistantly spaced apart from one another. In one such particularly preferred sensor trigger embodiment composed of at least a plurality of pairs, i.e., at least three, of equiangularly and/or equidistantly spaced apart sensor triggers, the sensor triggers includes a sensor trigger carrier, such as in the form of a plastic or nonmagnetic housing, to which all of the sensor triggers are mounted with the sensor trigger carrier releasably mounted to the spindle bar of the tip up fishing apparatus such that the sensor trigger carrier rotates in unison with the spindle bar, drive shaft, and spool of the tip up reel during tip up fishing apparatus use and operation. In such a particularly preferred sensor trigger arrangement 34, the sensor trigger carrier is generally circular, round, annular, disc-shaped or cylindrical such as in the form of a generally circular, round, annular, disc-shaped and/or cylindrical plastic or nonmagnetic metallic sensor trigger carrier wheel having at least a plurality of pairs of, i.e., at least three, equiangularly and/or equidistantly spaced apart sensor triggers, preferably at least four equiangularly and/or equidistantly spaced apart sensor triggers, more preferably at least five equiangularly and/or equidistantly spaced apart sensor triggers, even more preferably at least six equiangularly and/or equidistantly spaced apart sensor triggers and which can even have eight or more equiangularly and/or equidistantly spaced apart sensor triggers, if desired.

In at least one preferred embodiment, the carrier wheel is equipped with a rattle that is configured to make a noise, e.g., rattle, during each rotation or revolution of the wheel during ice fishing apparatus operation. In another preferred embodiment, the carrier wheel is has a mechanical clicker or mechanical clicking arrangement that is configured to make at least one click during each rotation or revolution of the wheel during fishing apparatus operation.

In a preferred embodiment, each sensor trigger of or used in any of the sensor trigger arrangements described in the preceding paragraph and in any of the paragraphs describing the second preferred system, sensing alarm unit, and sensor trigger arrangement embodiment and configuration is a steady-state source of a magnetic field, magnetic flux or flux density that is provided for or by each sensor trigger with a sensor trigger magnet that is a permanent magnet, such as a rare earth magnet. In one preferred embodiment, each sensor trigger is composed of or consists of a single permanent magnet of circular, disc-shaped, cylindrical, square or rectangular shape and arranged with the same respective common magnetic pole facing radially outwardly from the sensor trigger carrier, e.g., sensor trigger magnet carrier, such as preferably sensor trigger carrier wheel, such that the magnetic field, magnetic flux and magnetic flux density extends outwardly towards a sensor 28 of the sensor alarm unit that is a magnetic sensor 42 spaced from but in close enough proximity to the magnetic sensor 42 for the magnetic sensor 42 to sense at least one of the magnetic field, magnetic flux and/or magnetic flux density and/or a change in the magnetic field, magnetic flux and/or magnetic flux density, such as a change in the magnitude or strength of the magnetic field, magnetic flux and/or magnetic flux density, of each sensor trigger magnet passing by the magnetic sensor 42 of the sensing alarm unit 24 during rotation of the sensor trigger magnetic carrier, e.g., magnet carrier wheel, relative to the sensor 28 and sensing alarm unit 24 during tip up fishing apparatus use and operation. In another preferred embodiment, the trigger magnets are arranged with one magnetic pole, i.e., the north pole, of every other magnet facing radially outwardly from the sensor trigger magnet carrier, e.g., magnet carrier wheel, with the other magnetic pole, i.e., the south pole, of each magnet disposed in between every other magnet facing radially outwardly from the sensor trigger magnet carrier, e.g., magnet carrier wheel. In still another preferred embodiment, the equiangularly and/or equidistantly spaced trigger magnets are radially outwardly disposed on the sensor trigger magnet carrier, e.g., magnet carrier wheel, and oriented such that the magnetic poles of each magnet face generally circumferentially or tangentially relative to the carrier, e.g., carrier wheel, and thereby face generally transversely or orthogonally relative to the magnetic sensor 42 of the sensor alarm unit during rotation of the carrier, e.g., wheel, and magnets carried thereby relative to the magnetic sensor 42 and sensing alarm unit 24 during tip up fishing apparatus use and operation. If desired, the magnetic poles of each magnet can be oriented oppositely to the magnetic poles of the adjacent magnet disposed on each side thereof or the magnetic poles of each magnet can be oriented to face in the same direction as the magnetic poles of the adjacent magnet disposed on each side thereof.

As previously discussed, the sensor 28 of the sensing alarm unit 24 is a magnetic sensor 42 that preferably is a magnetoresistance or magneto-resistive magnetic sensor (MR magnetic sensor) that more preferably is a tunneling-magnetoresistance or tunneling-magneto-resistive magnetic sensor (TMR magnetic sensor) because an MR magnetic sensor, preferably TMR magnetic sensor, advantageously has greater sensitivity and/or selectivity in sensing one of (a) a magnetic field, magnetic flux, and/or magnetic flux density, e.g., magnitude thereof, outputted by a steady state magnetic field source thereof, e.g., permanent magnet, and (b) a change in the magnetic field, magnetic flux, and/or magnetic flux density, e.g., change in magnitude thereof, outputted by the steady state permanent magnet magnetic field source thereof, and has a greater signal output range corresponding thereto enabling more accurate, reliable and repeatable alarm triggering of the sensor alarm unit during operation of the equipment, preferably fishing apparatus, more preferably ice fishing tip up fishing apparatus, being monitored by the sensor alarm unit. The sensor alarm unit preferably also has at least one other type of onboard sensor such as preferably at least one or both of (a) an angle, orientation, position or movement sensor (AOPM sensor), such as an inclinometer, angle sensor, accelerometer, angular rate sensor, gyroscope, e.g., 3-axis, 6-axis gyro or 12-axis gyro, and/or multi-axis inertial measurement unit (IU), e.g., 3-axis, 6-axis or 12-axis IMU, configured to sense at least one of a change in angle, angular acceleration, orientation, rotation, motion or movement, linear acceleration, and/or position of the sensing alarm unit 24 and output a corresponding alarm trigger thereto that causes the sensing alarm unit 24 to alarm, and/or (b) one or more of a proximity, motion or distance sensor (PMD sensor) including one or more a proximity sensor, e.g., an infrared sensor such as a PIR sensor, a motion sensor, such as an ultrasonic motion sensor or radar sensor, and/or a distance sensor, such as an ultrasonic distance sensor or doppler sensor, configured to sense motion of a nearby object or a change in a distance relative to a nearby object and trigger the sensing alarm unit 24 into alarming.

In a preferred embodiment of a sensor trigger arrangement 34, the sensor trigger arrangement 34 is a generally circular, round, annular, disc-shaped or cylindrical sensor trigger magnet carrier wheel that carries at least a plurality, preferably at least a plurality of pairs of, i.e., at least three, e.g., four, five, six, seven or more, equiangularly spaced apart and/or equidistantly spaced apart permanent trigger magnets is three-dimensionally configured or contoured, such as by being molded, so as to fit over, snap onto, couple with, operatively connect to, or otherwise operably cooperate with one or more rotatable components of a fishing apparatus, such as one or more of a spool, reel, gears, rotor or other component of the fishing apparatus that rotate during operation of the fishing apparatus, in a manner such that the carrier and its trigger magnets rotate substantially in unison with rotation of the one or more rotatable components of the fishing apparatus upon and/or during occurrence of a fish strike and/or as well as during unspooling of fishing line from a spool of the reel of the fishing apparatus by the fish that first struck the bait running with the bait attached to the line after occurrence of the fish strike. In one preferred embodiment, the generally circular, round, annular, disc-shaped or cylindrical permanent magnet carrying carrier wheel is three-dimensionally contoured, e.g., mold, to fit over or onto the spindle bar of a tip up fishing apparatus, such as by being of snap-fit construction that removably snaps onto the spindle bar, in a manner that enables the carrier and magnets of the carrier to rotate in unison with the spindle bar, the drive shaft, and the spool of the reel of the tip up fishing apparatus during fishing use and operation. In another preferred embodiment, such a permanent trigger magnet carrying carrier wheel is configured to fit over, fit on, snap onto, couple with, operatively connect to or with, or otherwise operably cooperate with one of a spool, reel, rotor, handle, gearing, e.g., one or more gears, and/or other component(s) of a fishing apparatus that is one of a casting reel such as a baitcasting reel, a spincast reel or a spinning reel, a conventional reel or a trolling reel, an offshore reel, a surf reel, a bank fishing reel, a rattle reel, a fly fishing reel, or a centerpin reel or a centrepin reel which rotates during or from a fish strike and after the fish strike when the fish that took the bait runs with the bait unspooling line from the spool rotating the spool, reel, rotor, handle, one or more gears, and/or other component(s) of the fishing apparatus. In one such preferred embodiment, one of the spool, reel, rotor, handle or gear(s) of such a fishing apparatus that is one of a casting reel such as a baitcasting reel, a spincast reel or a spinning reel, a conventional reel or a trolling reel, an offshore reel, a surf reel, a bank fishing reel, a rattle reel, a fly fishing reel, or a centerpin reel or a centrepin reel has at least a plurality of equiangularly and/or equidistantly spaced apart magnetic sensor triggers 36a, 36b, preferably each in the form of a permanent magnet trigger magnet, mounted thereto, fixed thereto, formed therein, and/or molded therein or therewith for rotation substantially in unison therewith. In one particularly preferred embodiment, at least a plurality, preferably at least a plurality of pairs of permanent magnets are affixed to, mounted on, formed in, integrally formed with, integrally molded with or into a fishing line carrying spool of a reel of a fishing apparatus, such as a casting reel, e.g., baitcasting reel, spincast reel or spinning reel, a conventional reel or a trolling reel, an offshore reel, a surf reel, a bank fishing reel, a rattle reel, a fly fishing reel, or a centerpin reel or a centrepin reel.

The sensing alarm unit 24 preferably is mounted to ground by being mounted to a stationary non-rotating component of the fishing apparatus, such as (a) part of a frame of the casting reel, e.g., baitcasting reel, spincast reel or spinning reel, a conventional reel or a trolling reel, an offshore reel, a surf reel, a bank fishing reel, a rattle reel, a fly fishing reel, or a centerpin reel or a centrepin reel and/or (b) a fishing rod to which the casting reel, e.g., baitcasting reel, spincast reel or spinning reel, a conventional reel or a trolling reel, an offshore reel, a surf reel, a bank fishing reel, a rattle reel, a fly fishing reel, or a centerpin reel or a centrepin reel is removably mounted. The sensing alarm unit 24 is mounted to ground by being mounted to such a stationary non-rotating component of the fishing apparatus with its onboard magnetic sensor, preferably MR magnetic sensor, more preferably TMR magnetic sensor disposed adjacent to one of the sensor trigger magnet-carrying magnetic carrier wheel configurations described in the preceding paragraph that is carried by, mounted to, or an integral component of a fishing apparatus that is one of a baitcasting reel, such as a spincast reel or spinning reel, a conventional reel or trolling reel, an offshore reel, a surf reel, a bank fishing reel, a rattle reel, a fly fishing reel, or a centerpin reel or a centrepin reel.

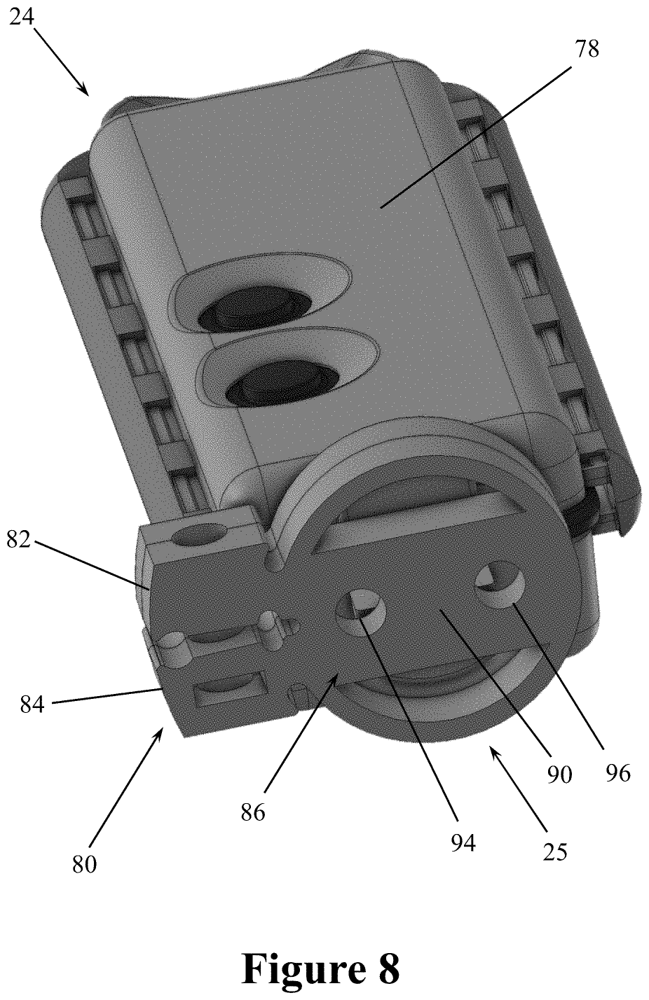

With reference to FIGS. 1 and 7-9, the sensing alarm unit 24 is removably attachable by a mounting arrangement 25 that is a multi-function mount 76 of versatile construction to a piece of equipment 22 being monitored by the sensing alarm unit 24. As previously discussed, in a preferred embodiment, the mount 76 is releasably attachable to either the flagpole 70 of a tip up 32 or the base or frame 44 of the tip up 32. The mount 76 is composed of a mounting base or pedestal 86 that is configured for releasable twist-on and twist-off engagement more preferably twist-lock engagement with a male mount docking arrangement 88 of the sensing alarm unit housing 78 that extends outwardly from one end, e.g., a bottom, of the housing 76 and which is three-dimensionally configured for twist-on engagement with the base or pedestal 86 of the mount 76 and for twist-off disengagement with the base or pedestal 86 of the mount 76. The mounting base or pedestal 86 of the mount 76 has a generally flat or planar bottom mounting surface 90 configured for secure mounting to a top surface 92, which is preferably a generally flat and/or substantially planar mounting surface 93, of a piece of equipment 22, such as preferably a tip up 32, which is to be monitored by the sensing alarm unit 24. Mounting preferably is preferably done by either adhesively affixing the generally flat or planar bottom surface of the mount base or pedestal 86 to the surface 92 of the piece of equipment 22 or by using a pair of fasteners received in a corresponding one of a pair of spaced apart mounting through bores 94, 96 that extend completely through the based or pedestal 86 of the mount 76.

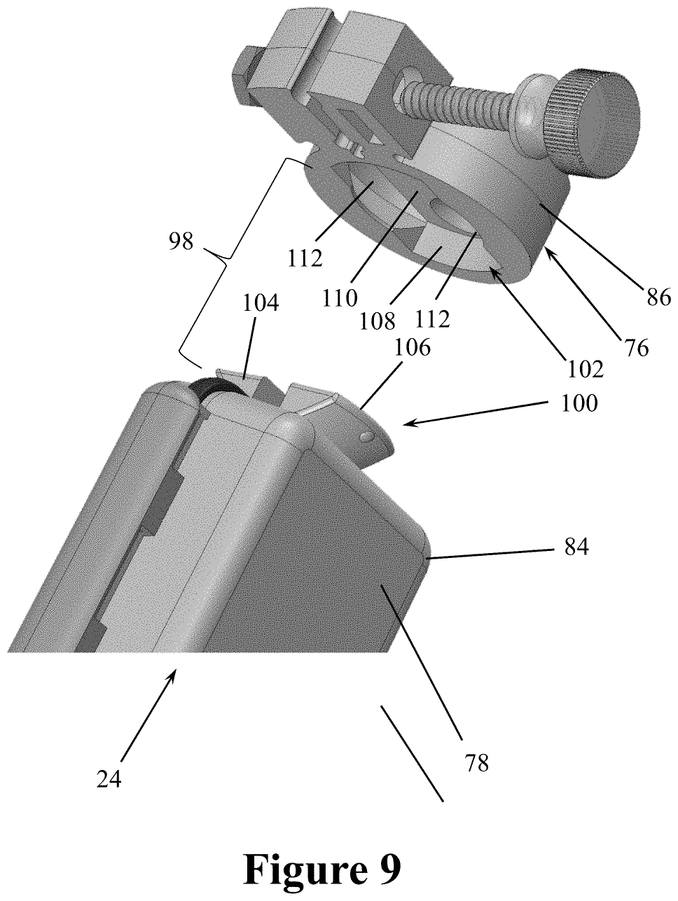

With additional reference to FIG. 9, the mounting pedestal or base 86 of the mount 76 is releasably mounted to the housing 78 of the sensing alarm unit 24 by a rotatable dovetail joint 98 formed via releasable twisting or rotational engagement therebetween where one of the sensing alarm unit housing 78 and the mounting pedestal or base 86 of the mount 76 has an outwardly extending male dovetail 100 that is rotatively received a dovetail receiving receptacle 102 formed in the other one of the sensing alarm unit housing 78 and the mounting pedestal or base 86 of the mount 76. In a preferred embodiment, the sensing alarm unit housing 78 has an outwardly extending oblong male dovetail 100 formed of a pair of outwardly extending flared dovetail ears 104, 106 and the mounting pedestal or base 86 of the mount 76 has a generally rectangular recessed dovetail receiving receptacle 102 formed therein having an enlarged generally circular dovetail insertion or docketing entranceway 108 configured for insertion of the male ears 104, 106 of the dovetail 100 until their ends bottom out against receptacle floor 110. Once the ears 104, 106 of the dovetail 100 are inserted into the dovetail receiving entranceway 108 until the dovetail ears bottom out against the receptacle floor 110, one of the mount 76 and sensor alarm unit 24 is twisted relative to the other one of the mount 76 and sensor alarm unit 24 until the dovetail ears 104, 106 are received in a corresponding one of a pair of ear receiving undercuts 112, 114 disposing the dovetail ears 104, 106 in interference engagement with parts of the pedestal or base 86 that form opposite sides and/or opposite ends of the recessed dovetail receiving receptacle 102 by underlying one or both the dovetail receptacle sides and/or ends.

In one preferred embodiment, the dovetail 100 is inserted into the dovetail receiving entranceway 108 of the receptacle 102 until the dovetail 100 bottoms out against the receptacle floor 110 and then one of the mount 76 and sensor alarm unit 24 is twisted relative to the other one of the mount 76 and sensor alarm unit 24 at least 20 degrees and preferably no more than 150 degrees relative to the mounting base for releasable twist-lock engagement of the mount 76 to the sensor alarm unit 24 to be achieved. In one such preferred embodiment, the ears of the dovetail 100 are inserted into the entranceway 108 of the receptacle 102 and twisted between about 35 degrees and 105 degrees to releasably secure the sensor alarm unit 24 to the mount 76 in a manner that prevents the sensor alarm unit 24 from pulling away or disengaging from the mount 76. In another preferred embodiment, the dovetail 100 is inserted into the receptacle 102 and the mount 76 is rotated relative to the sensing alarm unit 24 about 90° for releasable but secure twist locking engagement therebetween to occur.

The sensing alarm unit can be and preferably is configured to wirelessly communicate via radio frequency communications with a remote transportable user alarm unit of the sensing system that is configured to provide a human perceptible audible, visual, vibratory, or other type of human perceptible alarm to a user carrying the alarm unit upon a sensing event triggering an onboard sensor of the sensing alarm unit. The transportable user alarm unit can be further configured as a controller adapted to control at least a plurality of functions, operating parameters, and the like of the sensing alarm unit via two-way wireless communication with or between the sensing alarm unit. The transportable user alarm unit, including when configured as a controller, e.g., master controller, can be of portable hand-held construction and configured for manual, preferably one-hand operation, or can also be implemented in firmware or software, such via an app or software program, run by a processor-equipped multifunction electronic device, such as a smartphone, table, notebook computer, desktop computer or another type of suitable processer-equipped device.

The sensing alarm unit preferably has (a) a housing composed of a pair of generally rectangular box like plastic panels releasably secured together by a plastic generally U-shaped slide on panel locking clip that slidably engages the generally parallel opposite side edges of both housing panels to secure them together, and (b) internal components inside or carried by the housing of the the sensing alarm unit including a circuit board, an onboard processor mounted to the circuit board, an onboard magnetic sensor that preferably is a TMR sensor mounted to the circuit board, an onboard electrical power source that preferably is a AA or AAA battery for providing electrical power to the circuit board and electrical components carried by or mounted to the circuit board, at least one capacitor, a wireless radio frequency communications system, at least one LED that preferably is of color changing construction, at least one audio transducer that preferably is a speaker or piezoelectric transducer, a magnetically attractive magnet anchor preferably disposed adjacent the magnetic sensor and adjacent to, carried by or positioned against an internal surface of one of the housing panels to enable a magnetic sensor triggering magnet to be received and magnetically retained in place in a generally circular magnet seat target shown adjacent the “magnet” label on the outer surface of one of the housing panels, one or more of an accelerometer, gyro, IMIU, HRU, GPS sensor, magnetometer, inclinometer, tilt sensor and/or one or more other types of position sensors, and a plurality of sensor alarm unit controls and their corresponding generally round buttons disposed in openings in one of the housing panels.

The sensor alarm unit housing includes a twist lock mount that is composed of (a) a twist lock dovetail recess formed in the pedestal or base of the mount for receiving a pair of outwardly extending and flared dovetail ears of a male dovetail that is received in the dovetail recess and twisted or rotated, preferably about ninety degrees, to releasably secure the housing of the sensor alarm unit to the base or pedestal of the dovetail mount; and (b) components of the adjustable clamp jaw tightener or clamping draw clamp force adjuster that include a thumbscrew with an enlarged knurled head from which an elongated threaded stem extends through aligned through-bores in each clamp jaw and rotatably received in a threaded nut seated in a recessed nut seat nut formed in the jaw opposite the jaw against which the enlarged thumbscrew head bears or engages during clamping and clamp jaw tightening.

The sensor trigger arrangement is configured for positioning relative to one or more sensors of the sensing alarm unit in order to operatively interact or cooperate therewith, including remotely, to trigger one or more of the sensors of the sensing alarm unit upon the occurrence of relative movement therebetween. The sensor trigger arrangement can take the form of one or more sensor trigger configurations described in more detail hereinbelow having one or more sensor triggers, packaging configurations, mounting arrangements, and/or operating orientations which can be and preferably is tailored to the fishing, hunting, trapping or other outdoor or recreational application or equipment with which it is intended to be used.

The sensing alarm unit can have onboard wireless communications, sensing, and/or alarm circuitry as well as onboard magnetic, proximity, and/or other sensors in a configuration or arrangement similar to or substantially same as the sensor base unit disclosed in commonly owned U.S. Pat. No. 10,827,735, the entire disclosure of which is hereby expressly incorporated herein by reference. The sensing alarm unit, including its circuitry, sensors, and any other onboard electric components, is powered by an electrical power supply that preferably is disposed onboard the sensing alarm unit, which can be in the form of at least a plurality or plurality of pairs, i.e., at least three, D, C, AA, or AAA batteries, and which can be rechargeable. Further in accordance with the teachings of Applicant's aforementioned '735 patent, the sensing alarm unit can also be configured to wirelessly network with one or more other sensing alarm units to form a sensing network system which in turn can be configured to wirelessly communicate with a single or common transportable user alarm unit that can be further adapted as a controller, e.g., master controller, which controls one or more functions, parameters, and/or aspects of sensing alarm unit and/or sensing system operation. However, as disclosed in more detail below, it is contemplated that a sensing system, sensing alarm unit, sensor trigger arrangement, and transportable user alarm unit and/or master controller constructed and configured in accordance with the present invention will have several differences compared to the corresponding components of the alarm system disclosed in Applicant's aforementioned '735 patent.

A preferred embodiment of the sensing alarm unit is equipped with at least one onboard magnetic sensor that is at least one of a magnetic field sensor, magnetic flux sensor or magnetic flex density sensor that is constructed and/or configured to sense a magnetic field, change in magnetic field, change in magnetic field, magnetic field strength, change in magnetic field strength, magnetic flux, change in magnetic flux, a magnetic flux density and/or change in magnetic flux density of a sensor trigger arrangement that is a magnetic sensor trigger arrangement employing a magnetic trigger in the form of at least one magnet, e.g., rare earth permanent magnet, and output an electrical signal which the processor onboard the sensing alarm unit is configured in firmware and/or software to interpret as a magnetic sensor sensing event, e.g., magnetic sensor sensing event interrupt, preferably an alarm event, e.g., sensing alarm event interrupt, and generate a sensing event message that preferably is an alarm event message that causes at least one human perceptible alarm to be outputted. Where the sensing event is an alarm event, (a) at least one human perceptible alarm uniquely associated with a magnetic sensor sensing event in the form of at least one audible, visual, and/or vibratory alarm is outputted by or from the sensing alarm unit and/or (b) a corresponding magnetic sensor sensing alarm event message is wirelessly transmitted from the sensing alarm unit to the transportable user alarm unit or controller causing at least one human perceptible alarm uniquely associated with the magnetic sensor sensing event in the form of at least one audible, visual, and/or vibratory alarm to be outputted by or from the sensing alarm unit.

In a preferred magnetic sensor embodiment, at least one magnetic sensor onboard the sensing alarm unit and preferably each magnetic sensor onboard the sensing alarm unit is constructed and/or configured to be or function as a plurality of a magnetic field sensor, magnetic flux sensor and magnetic flux density sensor constructed and/or configured to sense at least a plurality of a magnetic field, change in magnetic field, magnetic field strength, change in magnetic field strength, magnetic flux, change in magnetic flux, magnetic flux density and/or change in magnetic flux density of a magnetic sensor trigger arrangement that has at least one steady state source of a magnetic field, magnetic flux and/or magnetic flux density in the form of at least one permanent magnet that preferably is a rare earth magnet. Each magnetic sensor onboard the sensing alarm unit preferably is a Magnetoresistance or Magneto-Resistive sensor (MR magnetic sensor) that employs a MR sensing element, which can be an Anisotropic Magnetoresistance sensor or Anisotropic Magneto-Resistive sensor (AMR magnetic sensor) or a Giant Magnetoresistance sensor or Giant Magneto-Resistive sensor (GMR magnetic sensor), but which preferably is a Tunnel Magnetoresistance sensor or Tunnel Magneto-Resistive (TMR magnetic sensor) because a TMR magnetic sensor provides greater signal output, possesses higher accuracy, greater magnetic field or flux sensitivity and/or selectivity, and better stability as result of less temperature drift and less aging deterioration, and is more versatile as a TMR sensor can be used as an angle sensor, a position sensor, and/or a rotary sensor.

Use of an MR magnetic sensor onboard the sensing alarm unit that preferably is a TMR sensor having such greater sensitivity, selectivity and signal output compared to a conventional reed switch or Hall magnetic sensor advantageously means sensing of the sensor trigger magnet of a magnetic sensor trigger magnet can occur where the magnet or other source of the sensed magnetic field is located a greater distance away from the TMR magnetic sensor. This enables a system with a sensing alarm unit equipped with an MR sensor that preferably is a TMR sensor to be used in sensing or alarm applications that do not require the trigger magnet to be seated in a magnetically attractive magnet seat of the sensor unit and pulled out of the seat in order to cause the magnetic sensor to trigger a magnetic sensor sensing event and output a corresponding alarm emanating either from the sensing alarm unit or the remotely located transportable alarm or controller. This therefore also enables such a system equipped with such a sensing alarm unit utilizing an MR sensor that preferably is a TMR sensor to be used in sensing or alarm applications not requiring an elongate tether or line, e.g., an elongate flexible string, rope, or wire, to be attached to the trigger magnet or part of a sensor trigger arrangement carrying the magnet in order to pull the trigger magnet from the magnet seat of the sensing alarm unit to trigger a magnetic sensor sensing event and output a corresponding alarm emanating either from the sensing alarm unit or the remotely located transportable alarm or controller. Such a magnet seat can be carried by, disposed on, or formed in the sensing alarm unit, e.g., carried by, disposed on or formed in a housing of the sensing alarm unit. The magnet seat can include or be disposed adjacent a magnetically attractive trigger magnet anchor, such as one made of a magnetic metallic material, carried by the sensor unit housing which helps releasably retain the trigger magnet in the seat via magnetic attraction therebetween until the magnet is pulled out of or from the seat by a force acting on the line or tether in a direction generally away from the seat. Where the magnetic sensor is a TMR magnetic sensor disposed onboard the sensing alarm unit, use of a TMR unit advantageously also enables the sensor trigger magnet to be located in nearly any position outside or external of the housing of the sensing alarm unit and spaced from the TMR magnetic sensor nearly any distance from the TMR magnetic sensor and from the sensing alarm unit housing in any direction when the trigger magnet is disposed in a predetermined set, armed, or trigger position so long as the strength of the magnetic field, magnetic flux and/or magnetic flux density is great enough to be sensed by the TMR magnetic sensor and used to establish, e.g., calibrate, a threshold magnetic field strength, magnetic flux, e.g., Br, and/or magnetic flux density and/or corresponding magnetic field strength, magnetic flux, e.g., Br, and/or magnetic flux density range to enable a change in one or more thereof falling below or outside of the threshold or threshold range to be determinative of the occurrence of movement, e.g., translation and/or rotation, of part of the equipment, e.g., fishing apparatus, preferably fishing apparatus, such as an ice fishing tip up, relative to the TMR magnetic sensor onboard the sensing alarm unit indicative of occurrence of an event or condition, such as a fish strike or fish unspooling line from a rotation spool or reel.

In at least one embodiment of a system and sensing alarm unit of the present invention, the sensing alarm unit has at least one TMR magnetic sensor that is configured as at least a plurality of an angle sensor, a position sensor, and a rotary sensor, such as by being configured to function as at least a plurality of angle sensor, a position sensor, and a rotary sensor. In at least one embodiment, at least one and preferably each sensing alarm unit of the system has at least one TMR magnetic sensor configured to sense at least a plurality of a magnetic field, change in magnetic field, magnetic field strength, change in magnetic field strength, magnetic flux, change in magnetic flux, magnetic flux density and change in magnetic flux density. In at least one further embodiment, at least one and preferably each sensing alarm unit of the system is equipped with at least one TMR magnetic sensor configured as at least a plurality of an angle sensor, a position sensor, and a rotary sensor where the TMR magnetic sensor is further configured to sense at least a plurality of a magnetic field, change in magnetic field, magnetic field strength, change in magnetic field strength, magnetic flux, change in magnetic flux, magnetic flux density and change in magnetic flux density.

In one preferred sensing alarm unit, the sensing alarm unit has at least one onboard magnetic sensor that preferably is a TMR magnetic sensor which communicates with the onboard processor and which is configured, such as in firmware and/or software, to sense magnetic transitions, such as in the form of a magnetic field transition, magnetic flux transition, and/or magnetic flux density transition of or caused by at least one trigger magnet such as by being configured to sense (a) an open condition upon occurrence of a first magnetic field transition caused by a change in one or more of magnetic field strength, magnetic flux and/or magnetic flux density of the at least one trigger magnet of a magnetic sensor trigger arrangement sensed by the TMR sensor with the open condition magnetic transition change being defined by a reduction in at least one or more of magnetic field strength, magnetic flux and/or magnetic flux density of the at least one trigger magnet of the magnetic sensor trigger arrangement sensed by the TMR sensor, and/or (b) a closed condition upon occurrence of a second magnetic field transition caused by a change in one or more of magnetic field strength, magnetic flux and/or magnetic flux density of the at least one trigger magnet of the magnetic sensor trigger arrangement sensed by the TMR sensor with the closed condition magnetic transition change being defined by an increase in at least one or more of magnetic field strength, magnetic flux, and/or magnetic flux density of the at least one trigger magnet of the magnetic sensor trigger arrangement sensed by the TMR sensor. In one preferred embodiment and implementation, (a) an open condition occurs as a result of one of the trigger magnet and magnetic sensor moving linearly, angularly, and/or rotatively relative to the other one of the trigger magnet and magnetic sensor away from one another a great enough distance, inclination or rotational angle such that the magnitude, amplitude or strength of the magnetic field, magnetic flux or magnetic flux density of the magnet sensed by, e.g., extending to or into or passing through, the magnetic sensor drops below a predetermined threshold magnetic field strength, magnetic flux or magnetic flux density, e.g., drops to zero or below zero, and (b) a closed condition occurs as a result of one of the trigger magnet and magnetic sensor moving linearly, angularly and/or rotatively relative to the other one of the magnet and sensor toward one another a large enough distance and/or inclination such that the magnitude, amplitude or strength of the magnetic field, magnetic flux or magnetic flux density of the magnet sensed by, e.g., extending to or into or passing through, the magnetic sensor reaches or exceeds a predetermined threshold magnetic field strength, magnetic flux or magnetic flux density.

Such a sensing alarm unit and magnetic sensor, preferably TMR sensor, disposed onboard the sensing alarm unit preferably is or are configured to sense or be capable of sensing (a) alternating open-closed-open-closed magnetic transitions of the trigger magnet where at least a plurality of open-closed transitions occur and are sensed by the magnet sensor during operation and/or (b) alternating closed-open-closed-open magnetic transitions of the trigger magnet where at least a plurality of closed-open transitions occur and are sensed by the magnetic sensor during operation. In one embodiment of a system, magnet sensor equipped sensing alarm unit, and sensor trigger arrangement consisting of or equipped with at least one trigger magnet that preferably is a single trigger magnet, alternating open and closed transitions can be caused by a corresponding positive or negative change in at least one or more of magnetic field strength, magnetic flux, and/or magnetic flux density of the magnet sensed by the magnetic sensor when in magnetic field or flux communication therewith resulting from a change in position, orientation, angle, inclination, and/or rotation of a component of a piece of equipment, preferably part of a fishing apparatus, to which the trigger magnet is attached and which correspondingly moves relative to the magnetic sensor of the sensing alarm unit used to monitor operation of the piece of equipment, preferably fishing apparatus.

In one preferred system and magnetic sensor equipped sensing alarm unit of the present invention, the sensor trigger arrangement is a magnetic sensor trigger arrangement equipped with and/or consisting of a single trigger magnet carried by and preferably mounted to a component of a fishing apparatus, such as a movable component of a fishing reel that moves during fishing reel operation, where the trigger magnet is disposed in close enough proximity relative to the magnetic sensor for the magnet to be in magnetic field or magnetic flux communication with the sensor such that the magnetic field force lines or magnetic flux lines of the trigger magnet extend to, preferably into, and more preferably pass through the magnetic sensor when the component of the fishing apparatus, preferably the movable component of the fishing reel, which carries the trigger magnet is disposed in a preset ready to trigger position or condition. In such a preferred system and magnetic sensor equipped sensing alarm unit, the sensing alarm unit is also mounted, preferably removably mounted, to the fishing apparatus, such as with a mounting arrangement substantially immovably fixed to part of the fishing reel or a rod carrying the fishing reel, to which the sensing alarm unit is removably attached.

In another preferred system, magnetic sensor equipped sensing alarm unit, and magnetic sensor trigger arrangement of the present invention, the sensor trigger arrangement has or consists of at least a plurality, preferably at least a plurality of pairs, i.e., at least three, spaced apart trigger magnets arranged in a magnet array that all have the same magnetic poles facing generally toward the magnetic sensor or which have alternating opposite magnetic poles facing generally towards the magnetic sensor. In one preferred multiple magnet sensor trigger arrangement, at least a plurality, preferably at least a plurality of pairs, i.e., at least three, permanent magnets are fixed to or embedded in an elongate flat or planar generally rectangular magnet holder, e.g., magnet-holding track, which preferably is made of a non-magnetic material, such as plastic. The magnets are equidistantly spaced apart from one another and arranged in a line along the elongate generally flat multiple magnet-holding track with alternating magnetic poles, e.g., north, south, north, south, of the magnets of the track facing outwardly generally toward the magnetic sensor of the sensing alarm unit during use and operation. If desired, the elongate generally flat multiple magnet-holding track can have two, three, four, five, six, seven or even more spaced apart trigger magnets adhesively attached to the track, attached with fasteners to the track, embedded in the track, and/or integrally molded with or in the track.

The multiple magnet-holding track can be of endless construction, such as where the track is arranged in a cylinder or generally circular wheel that is a generally cylindrical or wheel-shaped multiple magnet-holding track having at least a plurality, preferably at least a plurality of pairs, i.e., at least three, of trigger magnets with one of the poles of each magnet facing radially outwardly from a radial outer surface of the cylindrical or wheel-shaped multiple magnet-holding track and another one of the poles of each magnet facing radially inwardly from a radial inner surface of the cylindrical or wheel-shaped multiple magnet-holding track. In one preferred embodiment, the cylindrical or wheel-shaped multiple magnet-holding track can be constructed with two, three, four, five, six, seven or even more equiangularly and/or uniformly circumferentially spaced apart trigger magnets with the same pole, e.g., north pole, of each magnet facing one of radially outwardly or radially inwardly in the same direction and the opposite pole, e.g., south pole, of each magnet facing the other one of radially inwardly or radially outwardly in the opposite direction. If desired, the magnets can be arranged on the trigger magnet cylinder or wheel track with alternating radially outwardly and radially inwardly facing magnetic poles having the north pole of one magnet facing radially outwardly relative to and preferably from the magnet-carrying cylinder or wheel track and the south pole of the next adjacent magnet facing radially inwardly relative to and preferably from the magnet-carrying cylinder or wheel track.

The magnet-holding track, whether flat, planar, circular, wheel-shaped or cylindrical, preferably is fixed to a movable component of a piece of equipment, preferably a component of a fishing apparatus such as a spool or reel of a fishing reel, which moves during operation with the magnet-holding track preferably moving substantially in unison with movement of the movable component of the piece of equipment, preferably fishing apparatus, more preferably fishing reel. The sensing alarm unit is disposed adjacent the piece of equipment having its magnetic sensor, preferably TMR sensor, in close proximity to the flat, planar, round, cylindrical, or wheel-shaped magnet-holding track such that each magnet passing by the sensor during track and component movement is at least temporarily in magnetic field or magnetic flux communication therewith triggering the sensor each time one of the magnet passes by the sensor. In this way, movement of the movable component of the piece of equipment, preferably movement of movable component of the fishing apparatus, more preferably movement of movable component of fishing reel, moves the track and magnets carried by the track substantially in unison therewith, with movement of each one of the magnets triggering the sensor as the corresponding magnet passes by the sensor. The triggering of the magnetic sensor of the sensing alarm unit each time a trigger magnet passes by the sensor during track and movable component movement provides an indication of at least one of a change in movable component position, movable component orientation, and/or operational status of the equipment. The sensing alarm unit is mounted to or adjacent the piece of equipment with its magnetic sensor disposed in close enough proximity to the magnet-holding track for the sensor to be at least temporarily in magnetic field or flux communication with each one of the magnets of the track during movement of the component of the equipment carrying or coupled to the track.

In a preferred embodiment where the piece of equipment is a fishing apparatus having a movable component that preferably is a rotatable spool or rotatable reel of a fishing reel, the triggering of the magnetic sensor of the sensing alarm unit each time a trigger magnet passes by the sensor during track and movable component movement provides an indication of at least one of a change in movable component position, e.g., rotation of the spool or reel of the fishing reel, a change in movable component orientation, e.g., a change in orientation or angle of the movable component of the fishing apparatus, e.g., change in angle or orientation of the fishing line, spool or reel of the fishing reel, and/or a change in operational status of the fishing equipment, such as by the start of unspooling of fishing line from the spool or reel of the fishing reel or the movement, e.g., start of rotation, of the rotatable spool or reel of the fishing reel indicative of a fish strike and/or fish unspooling of line from the spool or reel of the fishing reel after a fish strike. In one preferred embodiment, the sensing alarm unit, preferably one or both the onboard process and MR sensor, preferably TMR sensor, are configured in software and/or firmware to sense not only a beginning of when movement of the movable component of the fishing apparatus occurs, preferably by being configured in software and/or firmware to magnetically detect or sense using the TMR sensor: (a) when rotation of the spool of a fishing reel starts during fishing use of the fishing reel, to thereby detect occurrence of a fish strike by a fish striking bait attached to fishing line spooled on the spool of the reel, (b) when continued unspooling of line from a spool of a fishing reel is occurring after a fish has struck and taken the bait in step (a), (c) an increase in an unspooling rate that fishing line is being unspooled from the spool of the fishing reel when a fish that has taken the bait after detection of a fish strike in step (a) is subsequently attempting to swim or run away and/or fight to take the bait and/or get free of the line, and/or (d) a decrease in the unspooling rate that fishing line is being unspooled from the spool of the fishing reel when a fish that has taken the bait after detection of a fish strike in step (a) and was attempting to fight or swim away tires or begins to tire therefrom.

As discussed in more detail below, a preferred sensing alarm unit is removably attached to a mount that is substantially immovably fixed or anchored to or adjacent the piece of equipment whose movable component movement is being monitored by the sensing alarm unit during equipment use and operation. The mount is located relative to the piece of equipment to position the magnetic sensor of the sensing alarm unit in magnetic field or flux communication of each magnet of the track as each magnet passes by the sensor as the magnet-holding track is moved relative to the sensor substantially in unison with movement of the movable component of the piece of equipment. The mount is preferably located in close enough proximity relative to the piece of equipment in order to position the magnetic sensor of the sensing alarm unit within 1-3 centimeters, preferably within 2-4 centimeters, more preferably within 3-6 centimeters, of each 30 gauss magnet of the magnet-holding track as it passes closest to the magnetic sensor that is at least a 9 gauss MR sensor, preferably at least a 30 gauss MR sensor, that is at least a 9 gauss TMR sensor, that preferably is at least a 30 gauss TMR sensor during movement of the track in unison with movement of the movable component of the piece of equipment.

It is an advantage of the present invention that the magnetic sensor trigger magnets traveling by the magnetic sensor during movement of the track substantially in unison with movement of the movable component of the piece of equipment can be sensed by the magnetic sensor as each magnet passes by the sensor over a distance of at least one centimeter, preferably at least two centimeters, and more preferably at least three centimeters from the sensor where each magnet is a rare earth magnet with a magnetic flux density, preferably residual flux density (Br), of at least 9 gauss and the sensor is at least a 9 gauss MR sensor that preferably is at least a 9 gauss sensor TMR sensor. It is a further advantage of the present invention that the trigger magnets passing by the magnetic sensor during movement of the track substantially in unison with movement of the movable component of the piece of equipment can be sensed by the magnetic sensor as each magnet passes by the sensor over a distance of at least one centimeter, preferably at least two centimeters, and more preferably at least three centimeters from the sensor where each magnet is a rare earth magnet that has a residual flux density or Br of at least 30 gauss and the sensor is at least a 30 gauss MR sensor that preferably is at least a 30 gauss TMR sensor. It is yet a further advantage that the magnetic sensor can be spaced advantageously at an even greater distance of between 5-10 centimeters from each trigger magnet traveling by the sensor during track movement caused by movement of the movable component of the piece of equipment where a more powerful neodymium magnet, samarium cobalt magnet, or aluminum nickel cobalt magnet having a residual flux density or Br of at least 100 gauss, preferably at least 500 gauss, and more preferably at least 1000 gauss where the magnetic sensor is an MR sensor that preferably is a TMR sensor.

In one preferred system and sensing alarm unit are configured for use in a fishing application that is a tip up ice fishing application and have at least one sensing alarm unit of the system configured as a fish strike indicator or fish strike indicator sensing alarm unit adapted for use with a fishing apparatus that is an ice fishing tip up by being configured (a) for mounting thereto, (b) to sense occurrence of a fish strike during fishing use of the tip up, and (c) to provide at least one human perceptible alarm, preferably by outputting one or more of (i) an audible alarm, e.g., sound, tone or siren, and/or (ii) a visual alarm, e.g., LED light, flashing strobe, rotating/flashing beacon, or flashing light, perceptible to a person, e.g., user or fisherman, located within hearing or sight range of the sensing alarm unit and tip up. Where the system includes a transportable alarm unit or controller that is carried on the person, e.g., user or fisherman, when they are located remotely out of sight and hearing range of the tip up and fish strike indicator sensing alarm unit mounted thereto, the fish strike indicator sensor unit is further configured to wirelessly communicate, such as via an RF digital signal, a wireless sensor event alarm message that is a fish strike indicator alarm message to the alarm unit or controller paired thereto that causes the alarm unit or controller to provide at least one human perceptible alarm, preferably by outputting one or more of (a) an audible alarm, e.g., sound, tone or siren, (b) a visual alarm, e.g., LED light, flashing strobe, rotating/flashing beacon, or flashing light, and/or (c) a haptic or vibratory alarm, perceptible to the person, e.g., user or fisherman, carrying the alarm unit or controller on their person, such as by being held in their hand, tethered to their wrist, disposed in their clothing, etc. While it is contemplated that a fish strike indicator sensing alarm unit paired for wirelessly communicating with a transportable alarm unit or controller is configured, sensing or occurrence of a fish strike, to cause the alarm unit or controller to output one or more audible, visual, and haptic/vibratory alarms at substantially simultaneously the same time as the sensing alarm unit itself is outputting one or more audible and visual alarms therefrom, the sensing alarm unit can be configured to only cause the alarm unit or controller to output one or more of the audible, visual and haptic/vibratory alarms such as upon selection of an alarm mode control setting of the sensing alarm unit and/or alarm unit or controller and/or detection of the alarm unit or controller being located a distance from the sensing alarm unit that is greater than a predetermined threshold distance, such as a distance greater than one mile.

In one preferred ice fishing tip up embodiment, the sensing alarm unit is configured for releasable but positively secure mounting to an elongate bendable fish strike indicator flagpole of a standard rail type ice fishing tip up anchored by coil spring at one end to an elongate transversely extending generally planar frame that serves as a generally horizontal base to support the tip up on the ice of a lake or pond during fishing use. Such a standard rail tip-up has a pair of spaced apart generally parallel horizontal support frame rails with an elongate water-tight hollow cylinder pivotably mounted therebetween that has a diameter approximately that of a large straw. The cylinder is pivotable between a generally parallel horizontal storage position where the cylinder is folded parallel to the frame rail thereby nesting between the frame rails, and an ice fishing tip up operating position where the cylinder is swung out from the base to a 90-degree angle relative to the base forming a T during use.

The cylinder generally coaxially houses an elongate internal stainless-steel drive shaft that has a free-spinning rotatable spool of a reel carrying fishing line at one end that is fixed to one end of the drive shaft for causing the shaft to rotate in unison therewith when a fish strikes the bait and unspools line from the spool of the submerged reel. At the other end of the cylinder is an elongate generally transversely extending notched spindle bar fixed to the opposite end of the drive shaft that rotates in unison with the shaft and the spool of the reel during unspooling of line from the spool of the reel from a fish strike.

The tip up is armed by bending the flagpole from its generally vertical fish-strike signaling position to a generally horizontal set or fish strike trigger position until part of the pole releasably engages the spindle bar by being received in a notch in the spindle bar releasably retaining the pole in the set or trigger position. When a fish strikes by taking the bait in their mouth, it unspools line from the spool of the reel attached to the bait rotating the drive shaft thereby also rotating the spindle bar. As the spindle bar turns, it causes the flagpole to disengage from the notch in the spindle bar releasing the pole and a brightly colored fish strike indicator flag attached to the free end of the flagpole. Once released, the flagpole springs back to its original vertical or upright fish-strike signaling position thereby making the fish strike indicator flag readily visible for anyone to see.

A magnetic sensor trigger arrangement containing a steady-state source of magnetic flux, preferably a permanent magnet, is carried by, preferably mounted to, the tip up base and disposed close enough to the magnetic sensor, preferably TMR sensor, of the sensing alarm unit carried by the flagpole to be sensed by the magnetic sensor when the flagpole is releasably engaged with the spindle bar in the generally horizontal set or trigger position. The magnet is positioned on one of the frame rails of the tip up base close enough to the magnetic sensor of the sensing alarm unit such that when the generally horizontal flagpole disengages from the spindle bar due to spindle bar rotation caused by a fish striking the bait, the sensor unit moves substantially in unison with the flagpole as it springs upwardly rotating the flagpole away from the trigger magnet and towards the generally vertical fish-strike signaling position.

Although FIG. 1 shows a sensor trigger arrangement with a trigger magnet that is simply a permanent magnet adhesively fixed or attached by one or more fasteners to the upper outer surface of one of the tip up frame rails with one of its poles facing upwardly away from the frame rail and the other one of its poles facing downwardly towards the frame rail, the sensor trigger arrangement can take the form of a housing that is releasably or permanently mounted on the upwardly facing outer tip up frame or base surface that contains or carries a magnetic trigger, e.g., trigger magnet, which preferably also is a permanent magnet. Where the magnetic trigger of the sensor trigger arrangement is a permanent magnet, the permanent magnet or a sensor trigger arrangement having a housing carrying the permanent magnet is immovably fixed to an upwardly facing surface of the frame or base of the tip up at a position on the tip up frame or base that locates the magnet adjacent to the sensor unit when the pole of the flag is releasably retained by the spindle bar in the set or fish strike trigger detecting position. Where the magnetic sensor trigger arrangement consists of a permanent magnet, the magnet can be circular or cylindrical, rectangular or square in shape or cross-section oriented with one of its magnetic poles facing generally upwardly and the other one of its magnetic poles facing downwardly. The magnet can also be recessed into, countersunk in, embedded in, or even encapsulated within a frame rail of the tip up.

The sensing alarm unit is configured to be selectively positioned or selectively positionable along the flagpole to which it is releasably mounted to position its magnet sensor, preferably TMR sensor, in close enough proximity to the magnet of the sensor trigger arrangement fixed to the tip up base to detect relative movement therebetween in a direction away from the magnet when a fish strike disengages the flagpole from the spindle bar. When the flagpole is in the set or trigger position, the magnetic sensor and sensing alarm unit overlies the magnet and is disposed in close enough proximity thereto such that the magnetic field, flux or flux density reaching the magnetic sensor is greater than a predetermined threshold field strength, flux, or flux density that prevents the sensor from triggering a sensor alarm event interrupt or sensor alarm event message.

When a fish strikes and causes the flagpole to disengage from the rotating spindle bar, the strength of the magnetic field, magnetic flux and/or magnetic flux density reduces as the magnetic sensor and sensing alarm unit move with the flagpole vertically away from the magnet until to falls below a threshold field strength, flux or flux density of the sensor that causes a sensor alarm event signal or sensor alarm event interrupt to be issued to the processor onboard the sensing alarm unit. Occurrence of such a sensor alarm event causes the sensing alarm unit to activate and/or energize one and preferably both of (a) a light, which can be in the form of a light bright enough to be seen for at least 1000 yards, such as a bright flashing strobe, a bright LED light or lamp, or other type of light source, and/or (b) an audio transducer, such as in the form of a loudspeaker, piezoelectric sound transducer, or other type of sound emitting transducer to provide a visually and audibly perceptible fish strike alarm. Occurrence of such a sensor alarm event also causes the sensing alarm unit to wirelessly transmit a sensor alarm event message to the remotely-located user transportable alarm unit or controller causing the alarm unit or controller to activate and/or energize at least one and preferably at least a plurality of (a) a light, such as one or more LEDs, (b) an alarm sound-outputting audio transducer, such as a speaker and/or piezoelectric transducer or actuator, and/or (c) an alarm vibration outputting haptic actuator, such as one or more of a linear resonant actuator (LRA), eccentric rotating mass actuator (ERM), and/or a piezoelectric actuator to provide at least one different type and preferably at least a plurality of different types of fish strike alarm(s) to the user.

As the flagpole and sensing alarm unit move in unison upwardly, the sensing alarm unit moves away from the trigger magnet fixed to the tip up frame rail causing the magnetic sensor, preferably TMR sensor, to open or close, depending on its configuration, and signal the processor onboard the sensing alarm unit of the occurrence of a sensing event that is a sensing alarm event. As the magnetic sensor moves in unison with the sensing alarm unit and tip up flagpole away from the trigger magnet, the magnet's magnetic field strength, magnetic flux, or magnetic flux density decreases until it drops below a predetermined flux threshold or predetermined flux density threshold that triggers the magnetic sensor, preferably TMR sensor, to signal the onboard processor of the occurrence of a magnetically triggered sensing alarm event. To facilitate such suitably sensitive sensing of the change in flux or flux density of the trigger magnet, preferably the decrease in flux or flux density thereof, which occurs during relative movement between the magnetic sensor and trigger magnet caused by them separating from one another during fish-strike indicating flagpole movement, the trigger magnet preferably is mounted to the frame or base of the tip up with one of its poles, such as its north pole or south pole, facing toward the sensing alarm unit and its onboard TMR magnetic sensor.

Once such a sensing event occurs that is a sensing alarm event triggered by such a magnetic trigger trigging the magnetic sensor of the sensing alarm unit mounted to the ice fishing tip up flagpole, the onboard processor of the sensing alarm unit is configured in firmware and/or software to provide a human perceptible alarm in the form of a light or strobe carried by the sensing alarm unit that is energized by the sensing alarm unit. Such a sensing alarm unit adapted for tip up use is further configured in firmware and/or software to wirelessly send a sensing event message that is a sensing alarm event message to a hand-held manually operable portable transportable user alarm unit or controller paired therewith thereby causing the user alarm unit or controller to output a human perceptible alarm in the form of one or more of emit an audible tone, energize one or more lights, e.g., LED(S), and/or output a haptic alarm, such as in the form of a vibratory alarm that vibrates the user alarm unit or controller. Because the sensing alarm unit and user alarm unit or controller are configured for wireless communication, preferably bidirectional wireless communication, therebetween over distances of at least one half mile, preferably at least one mile, and more preferably at least one and a half miles, the user alarm unit or controller is configured to provide at least a plurality, preferably a plurality of pairs of audible, light and haptic alarms substantially simultaneously upon receiving a wireless sensing event message from the sensing alarm unit that is a wireless sensing alarm event message.

When the flagpole is reengaged with the releasable tip up trigger mechanism by bending the pole about its coil spring anchored to the tip up frame or base until a generally horizontal portion of the flagpole is releasably received and retained in the notch in the spindle bar, the magnetic flux or flux density of the magnetic field lines of the trigger magnet are sensed by the magnetic sensor, preferably TMR sensor, thereby resetting and/or rearming the sensing alarm unit readying the sensing alarm unit to sense another magnetically triggered fish strike sensing event. The sensing alarm unit and/or user alarm unit or controller can be configured so that a control, setting or input of one or both is operated when the magnet sensor of the sensing alarm unit on the vertically oriented fish-strike indicating flag and flagpole is returned to the generally horizontal fish strike detecting or triggering position thereby resetting the sensing alarm unit so it will output a fish strike sensing event message upon the occurrence of the next fish strike.

In a preferred embodiment where the onboard magnetic sensor is a TMR sensor, the processor and/or TMR sensor can be configured in firmware and/or software to detect or determine an angle of the TMR sensor and preferably also the sensing alarm unit relative to a generally vertical orientation of the magnetic field or flux lines of the trigger magnet by virtue of the trigger magnet being fixed to the tip up base or frame with one of its north and south poles facing generally upwardly generally perpendicular to the generally horizontal base or frame and the other one of its north and south poles facing generally upwardly generally perpendicular to the generally horizontal base or frame.

In one such preferred sensing alarm unit embodiment, the processor and/or magnetic sensor onboard the sensing alarm unit operatively communicates with one or more of an angle, position, or orientation sensor that is configured to sense a change in one or more of an angle, position, or orientation of the sensing alarm unit and/or magnetic sensor onboard the sensing alarm unit. Where equipped with one or more sensors configured to sense one or more of a change in angle, position, or orientation of the sensing alarm unit during use and operation of the sensing alarm unit, the processor of the sensing alarm unit can be configured in software and/or firmware to (a) reset the sensing alarm unit readying it for fish strike detection when the flagpole and sensing alarm unit are generally horizontally disposed when the flagpole is releasably retained by engagement with the spindle bar orienting the flagpole and sensing alarm unit in the generally horizontal “armed” position, and/or (b) detect occurrence of a fish strike by detecting a change in angle, change in angular acceleration, change in orientation and/or change in position upon disengagement of the flagpole from the spindle bar upon occurrence of a fish strike. In a preferred embodiment, the presence of such of one or more angle, position, or orientation sensors onboard the sensing alarm unit provides a double-check or confirmatory determination of the occurrence of a fish strike by providing the onboard processor with an indication, e.g., interrupt or signal, of a change in angle, position or orientation of the sensing alarm unit substantially simultaneously with the magnetic sensor, preferably TMR sensor, providing an indication, e.g., interrupt or signal, to the processor of a sensed drop in magnetic field, magnetic flux, or magnetic flux density strength indicative of the magnetic sensor and sensing alarm unit moving away from the trigger magnet of the sensor trigger arrangement fixed to the tip up frame or base. Where equipped with one or more angle, position, or orientation sensors onboard the sensing alarm unit, such sensors include at least one and preferably at least a plurality of an onboard inclinometer, an angle sensor, e.g., piezoelectric “driftless” angle sensor, an accelerometer, such as a piezoelectric accelerometer, a piezoresistance accelerometer, or a capacitive accelerometer that can be of 3-axis accelerometer construction, an angular rate sensor, such as a piezoelectric angular rate sensor or a microelectromechanical systems or MEMS angular rate sensor, a gyro or gyroscope, such as a fiber optic or FOG gyro, a ring laser gyro, a nanophotonic optical gyroscope, a tunneling magneto-resistive micro-gyroscope, or a vibrating beam micro/nano gyroscope, and/or an inertial measurement unit (IMU), such as a multi-axis IMU, which preferably is an at least a 3-axis IU and more preferably is at least a 6-axis IMU, to sense, determine, or obtain the angular orientation, preferably angle of inclination of the sensing alarm unit and flagpole relative to the generally horizontal tip up frame or base to automatically confirm resetting of the sensing alarm unit to enable it to be ready to detect occurrence of another fish strike event with the tip up.

In another preferred sensing alarm unit embodiment, no magnet is needed nor used as the sensing alarm unit instead relies on an inclinometer, angle sensor, angular rate sensor, gyro or gyroscope, and/or multi-axis IMU, preferably at least a 3-axis IMU, more preferably 6-axis or 12-axis IMU, located onboard or inside the sensing alarm unit to sense a fish strike by sensing (a) release of the flagpole from the spindle bar that rotates free of engagement with the pole during a fish strike, and (b) the rapid rotation of the flagpole and sensing alarm unit carried by the pole as the released flagpole springs from the generally horizontal set or trigger position to the vertical or upright fish strike indicator position. In such a preferred sensing alarm unit embodiment, the internal or onboard inclinometer, angle sensor, angular rate sensor, gyro or gyroscope, and/or multi-axis IMU is disposed with a sensing axis thereof oriented relative to the flagpole, more preferably relative to a central longitudinal axis of the pole, in a manner that enables sensing of the change in angle of the fish-strike released moving flagpole (and sensing alarm unit carried thereby), rate of change in angle of the fish-strike released moving flagpole (and sensing alarm unit carried thereby), and/or angular acceleration of the rotation of the fish-strike released moving flagpole (and sensing alarm unit carried thereby), after or upon disengagement from the spindle bar by rotation caused by a fish strike, as the spring-loaded or spring-mounted flagpole rapidly springs from the horizontal set or trigger position to the upright or vertical fish strike indicator position. In such a preferred sensing alarm unit embodiment, one or both of the (a) onboard processor and (b) inclinometer, angle sensor, angular rate sensor, gyro or gyroscope, and/or multi-axis IMU are configured in firmware and/or software to sense one of a (a) change in angle of the fish-strike released moving flagpole as the flagpole moves from the generally horizontal set or fish strike trigger position, (b) rate of change in angle of the fish-strike released moving flagpole as the flagpole moves from the generally horizontal set or fish strike trigger position, (c) the angular acceleration of the fish-strike released moving flagpole as the flagpole moves from the generally horizontal set or fish strike trigger position, and/or (d) the rate of change in the angular acceleration of the fish-strike released moving flagpole as the flagpole moves from the generally horizontal set or fish strike trigger position. In at least one such preferred sensing alarm unit embodiment, the internal or onboard inclinometer, angle sensor, angular rate sensor, gyro or gyroscope, and/or multi-axis IMU is disposed with a sensing axis thereof oriented relative to the flagpole, more preferably relative to a central longitudinal axis of the pole, in a manner that enables sensing of the change in angle, rate of change in angle, and/or angular acceleration of the rotation of the flagpole, after or upon disengagement from the spindle bar by rotation caused by a fish strike, as the spring-loaded or spring-mounted flagpole rapidly springs from the horizontal set or trigger position to the upright or vertical fish strike indicator position. In such a preferred sensing alarm unit embodiment, one or both of the (a) onboard processor and (b) inclinometer, angle sensor, angular rate sensor, gyro or gyroscope, and/or multi-axis IMU are configured in firmware and/or software to sense one of a (a) change in angle of the fish-strike released moving flagpole by sensing the change in angle of the sensing alarm unit mounted to the flagpole of or along an axis of the sensing alarm unit generally parallel to the central longitudinal axis of the flagpole, (b) rate of change in angle of the fish-strike released moving flagpole by sensing rate of change in angle of the sensing alarm unit mounted to the flagpole of or along an axis of the sensing alarm unit generally parallel to the central longitudinal axis of the flagpole, (c) the angular acceleration of the fish-strike released moving flagpole by sensing rate of change in angle of the sensing alarm unit mounted to the flagpole of or along an axis of the sensing alarm unit generally parallel to the central longitudinal axis of the flagpole, and/or (d) the rate of change in the angular acceleration of the fish-strike released moving flagpole by sensing rate of change in angle of the sensing alarm unit mounted to the flagpole of or along an axis of the sensing alarm unit generally parallel to the central longitudinal axis of the flagpole.

In a preferred embodiment, the sensing alarm unit is configurable to provide or operate as a fish strike indicator with the magnetic sensor onboard configured to sense one or more of (a) a magnetic field, magnetic flux, or magnetic flux density of a magnetic field source that preferably is a source of a steady-state magnetic field, which more preferably is provided by at least one permanent magnet, (b) a strength or magnitude of the magnetic field, magnetic flux or magnetic flux density of the magnetic field source that preferably is a steady-state magnetic field source which more preferably is provided by at least one permanent magnet, and/or (c) a change in the strength or magnitude of the magnetic field, magnetic flux or magnetic flux density of the magnetic field source that preferably is a steady-state magnetic field source which more preferably is provided by at least one permanent magnet and provide an indication of a fish strike, such as in the form of an audible, visible, or haptic, e.g., vibratory, user perceptible or detectable feedback, preferably by sensing a rotation of a fishing apparatus by sensing rotation of a fishing-line carrying spool of a fishing reel. Such a sensing alarm unit configured as a fish strike indicator of the present invention is configured to determine an occurrence of a fish strike by detecting rotation of one or more components of a fishing apparatus preferably by detecting rotation of a spool of a fishing reel that can be a casting reel such as a baitcasting reel, a spincast reel or a spinning reel, a conventional reel or a trolling reel, an offshore reel, a surf reel, a bank fishing reel, a rattle reel, a fly fishing reel, a centerpin reel or a centrepin reel, and/or a reel of an ice fishing tip up. It is also contemplated within the scope of the present invention to provide a sensing alarm unit that is a fish strike indicator or configured to provide an indication of a fish strike which is further configured to determine an occurrence of a fish strike by detecting rotation of one or more of (a) a rotor, bail, handle, line spool and/or one or more internal gears that operatively couple the handle to the rotor and/or to the spool of a spincasting fishing reel, (b) a handle, drive gear, drive shaft, pinion gear, main shaft, line guide and/or spool of a baitcasting fishing reel, (c) a spool, spool cover, and/or gearing of a fly reel, and/or (d) the spindle bar, drive shaft and/or spool of a tip up ice fishing reel.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

1. An alarm system comprising:
a base;
an opening contained within the base;
an upright having a top and a bottom extending through the opening;
a crossbar extending from the upright adjacent to the top;
a spool located adjacent to the bottom;
a sensor unit housing having at least one mounting mechanism, the sensor housing unit containing:
a power source;
at least one sensor; and
a processor;
wherein the sensor unit housing is movable between:
a first configuration in which the at least one mounting mechanism is secured to a flag pole; and
a second configuration in which the at least one mounting mechanism is secured to the base adjacent to the crossbar; and
wherein an alarm is distributed from the sensor unit housing when rotation of the spool occurs.

2. The alarm system of claim 1, further comprising at least one magnet associated with one or more of the upright and the crossbar;
wherein in the second configuration the at least one sensor detects rotation of the upright and the crossbar based on magnetic signals from the at least one magnet.

3. The alarm system of claim 1, further comprising at least one magnet associated with the crossbar;
wherein in the second configuration the at least one sensor detects rotation of the crossbar based on magnetic signals from the at least one magnet.

4. The alarm system of claim 3, wherein the at least one sensor detects one of the speed or number of rotations of the crossbar.

5. The alarm system of claim 4, wherein the sensor unit housing further comprises at least one LED light; and
wherein the at least one LED light flashes a first light sequences when a first speed or number of rotations of the crossbar is detected by the at least one sensor; and
wherein the at least one LED light flashes a second light sequences when a second speed or number of rotations of the crossbar is detected by the at least one sensor.

6. The alarm system of claim 4, wherein the sensor unit housing wirelessly transmits a signal to a master controller located away from the sensor unit housing.

7. The alarm system of claim 1, wherein the at least one sensor is a TMR sensor.

8. The alarm system of claim 7, wherein the at least one sensor is a unipolar sensor.

9. The alarm system of claim 7, wherein the at least one sensor is a bipolar sensor.

10. The alarm system of claim 1, further comprising a magnet associated with the base;
wherein the at least one sensor in the sensor unit housing detects the presence of the magnet in the first configuration when the flag pole is in an armed position;
wherein the at least one sensor in the sensor unit housing detects the lack of presence of the magnet when the flag pole is moved to a disarmed position; and
wherein the sensor unit housing notifies a user when the flag pole is moved to a disarmed position.

11. The alarm system of claim 10, wherein the sensor unit housing is vertically displaced from the magnet when the flag pole is in an armed position.

12. The alarm system of claim 1, wherein the at least one sensor is an accelerometer that detects acceleration of the sensor unit housing.

13. The alarm system of claim 1, wherein the at least one mounting mechanism further comprises:
a plurality of flexible fingers;
a thumbscrew; and
at least one fastener opening;
wherein the thumbscrew twists to tighten the fingers around the flag pole in the first configuration; and
wherein at least one fastener can be inserted into the base through the at least one fastener opening in the second configuration.

14. An alarm system for a fishing apparatus comprising a sensing alarm unit comprised of a sensor and a processor configured to monitor the sensor and output one of a human perceptible alarm and a wirelessly transmitted alarm when the sensor senses an alarm event, and a mounting arrangement configured for mounting of the sensing alarm unit to part of the fishing apparatus.

15. The alarm system of claim 14, wherein the mounting arrangement comprises one of (a) a clamp, and (b) one of (i) a dovetail joint and (ii) a twist-lock joint.

16. The alarm system of claim 15, wherein the mounting arrangement comprises both (a) the clamp, and (b) the one of (i) the dovetail joint and (ii) the twist-lock joint.

17. The alarm system of claim 16, wherein the mounting arrangement comprises a twist-lock rotary dovetail joint.

18. The alarm system of claim 14, wherein the fishing apparatus comprises a ground and a movable component that is movable relative to the ground during fishing apparatus operation, the mounting arrangement of the sensing alarm unit comprising a first mount configured for mounting the sensing alarm unit in operable cooperation with the movable component of the fishing apparatus for movement of the sensing alarm unit in response to movement of the movable component of the fishing apparatus during fishing apparatus operation, and a second mount configured for mounting the sensing alarm unit to the ground of the fishing apparatus.

19. The alarm system of claim 18, further comprising a sensor trigger mounted in one of operable cooperation with the ground and the movable component of the fishing apparatus, wherein the sensor of the sensing alarm unit is configured to sense or detect one of the sensor trigger, a presence or absence of the sensor trigger, and movement of one of the sensor and the sensor trigger relative to the other one of the sensor and the sensor trigger and cause the processor to output the one of the human perceptible alarm and wirelessly transmitted alarm in response to one of the sensor sensing the sensor trigger, the sensor sensing the presence or absence of the sensor trigger, and the sensor sensing movement of one of the sensor and the sensor trigger relative to the other one of the sensor and the sensor trigger.

20. The alarm system of claim 14, wherein the fishing apparatus comprises a ground and a movable component that is movable relative to the ground during fishing apparatus operation, further comprising a sensor trigger mounted in operable cooperation with one of the ground and the movable component of the fishing apparatus, wherein the sensing alarm unit comprises (a) a first mount configured for mounting the sensing alarm unit in operable cooperation with one of the ground and the movable component of the fishing apparatus when the sensor trigger is mounted in operable cooperation with one of the movable component and the ground of the fishing apparatus, and (b) a second mount configured for mounting the sensing alarm unit in operable cooperation with the other one of the ground and the movable component of the fishing apparatus when the sensor trigger is mounted in operable cooperation with the other one of the movable component and the ground of the fishing apparatus.

21. The alarm system of claim 20, wherein the sensor of the sensing alarm unit is configured to sense or detect one of the sensor trigger, a presence or absence of the sensor trigger, and movement of (a) one of the sensor and the sensor trigger relative to the other one of the sensor and the sensor trigger, and (b) one of the sensing alarm unit and the sensor trigger relative to the other one of the sensing alarm unit and the sensor trigger.

22. The alarm system of claim 21, wherein the processor is configured to output one of the human perceptible alarm and the wirelessly transmitted alarm in response to the sensor sensing the sensor trigger, the presence or absence of the sensor trigger, or movement of (a) one of the sensor and the sensor trigger relative to the other one of the sensor and the sensor trigger, and (b) one of the sensing alarm unit and the sensor trigger relative to the other one of the sensing alarm unit and the sensor trigger.

23. The alarm system of claim 21, wherein the sensor trigger comprises one of a magnetic field and source of magnetic flux, and the sensor comprises one of a magnetic field sensor and magnetic flux sensor.

24. The alarm system of claim 23, wherein the sensor trigger comprises a magnet, and the sensor comprises a magnet sensor.

25. The alarm system of claim 23, wherein the sensor comprises a magnetoresistance sensor or MR sensor.

26. The alarm system of claim 23, wherein the sensor comprises a tunneling magnetoresistance sensor or TMR sensor.

27. The alarm system of claim 14,
(a) wherein the fishing apparatus comprises an ice fishing tip up having a base and a plurality of movable components movable relative to the base comprising a flagpole, a rotary drive shaft carried by the base, a reel or spool disposed at or adjacent one end of the drive shaft that rotates the drive shaft when a fish strikes, and a crossbar bar disposed at or adjacent an opposite end of the drive shaft that is rotated by the drive shaft when a fish strikes, the flagpole releasably retained in a generally horizontal position by releasable engagement with the crossbar and movable from the generally horizontal position toward or to a generally vertical upright position when disengaged from the crossbar when the reel or spool rotates the drive shaft and crossbar during a fish strike;
(b) the alarm system further comprising a magnet mounted in operable cooperation with at least one of the movable components and the base of the ice fishing tip up; and
(c) wherein the sensing alarm unit comprises a (i) a first mount configured for mounting the sensing alarm unit in operable cooperation with one of the base and at least one of the movable components of the ice fishing tip up when the magnet is mounted in operable cooperation with at least one of the movable components and the base of the ice fishing tip up, and (ii) a second mount configured for mounting the sensing alarm unit in operable cooperation with the other one of the base and the at least one of the movable components of the fishing apparatus when the magnet is mounted in operable cooperation with the other one of the at least one of the movable components and the base of the fishing apparatus, the sensor of the sensing alarm unit comprising a magnet sensor.

28. The alarm system of claim 27, wherein the magnet is carried by one of the crossbar and the drive shaft of the ice fishing tip up and the sensing alarm unit is configured for mounting by one of the first and second mounts to the base of the ice fishing tip with the magnet sensor disposed adjacent the magnet for sensing movement of the magnet relative to the magnet sensor during rotation of the one of the crossbar and drive shaft by a fish strike.

29. The alarm system of claim 28, wherein the magnet has a north magnetic pole and a south magnetic pole, and the magnet is mounted to one of the crossbar and drive shaft with one of the north and south magnetic poles of the magnet facing radially outwardly from the drive shaft in one direction and other one of the north and south magnetic poles of the magnet facing radially outwardly from the drive shaft in an opposite direction.

30. The alarm system of claim 29, further comprising a magnet housing configured for snap fit attachment to one of the crossbar and the drive shaft of the ice fishing tip up, the magnet attached to or carried by the magnet housing.

31. The alarm system of claim 28, comprising a plurality of the magnets spaced apart and carried by one of the cross bar and drive shaft.

32. The alarm system of claim 31, wherein the sensing alarm unit has a plurality of spaced apart magnet sensors.

33. The alarm system of claim 31, further comprising a magnet housing configured for snap fit attachment to one of the crossbar and the drive shaft of the ice fishing tip up, the plurality of magnets attached to or carried by the magnet housing.

34. The alarm system of claim 31, wherein each one of the plurality of magnets has a north magnetic pole and a south magnetic pole, and each one of the plurality of the magnets oriented relative to the crossbar and driveshaft with one of the north and south magnetic poles facing generally radially outwardly relative thereto.

35. The alarm system of claim 34, wherein one of the plurality of the magnets is oriented relative to the crossbar and driveshaft with one of the north and south magnetic poles of one of the plurality of magnets facing generally radially outwardly relative to the drive shaft away from the drive shaft in one direction, and the other one of the north and south magnetic poles of another one of the plurality of magnets facing generally radially outwardly relative to the drive shaft away from the drive shaft in another direction.

36. The alarm system of claim 35, wherein one of the north and south magnetic poles of one of the plurality of magnets is oriented to face generally radially outwardly relative to the drive shaft away from the drive shaft in one direction, and the other one of the north and south magnetic poles of another one of the plurality of magnets is oriented to face generally radially outwardly relative to the drive shaft away from the drive shaft in the opposite direction.

37. The alarm system of claim 36, wherein the magnet sensor comprises a MR sensor or a TMR sensor.

38. The alarm system of claim 27, wherein the magnet is fixed to the base adjacent the flagpole and the sensing alarm unit is configured for mounting by one of the first and second mounts to the flagpole for movement substantially in unison therewith with the magnet disposed adjacent the magnet when the flagpole is disposed in the generally horizontal position and movable away from the magnet when the flagpole disengages from the crossbar and moves towards or to the generally vertical position by a fish strike.

39. The alarm system of claim 38, wherein the sensing alarm unit comprises a second sensor configured to sense one of movement, linear motion, angular motion, change in position, change in angle, rotation, and change in orientation of the sensing alarm unit during movement of the flagpole and the sensing alarm unit from the generally horizontal position towards or to the generally vertical fish strike indicating position during a fish strike.

40. The alarm system of claim 39, wherein the second sensor comprises one of a motion sensor, a position sensor, an angle sensor, a tilt sensor, a proximity sensor, a distance sensor, a radar sensor, an acceleration sensor, and a velocity sensor, the second sensor configured to cause the processor to output one of a user perceptible fish strike alarm and a wirelessly transmitted fish strike alarm when the second sensor senses one of one of displacement, translation, change in angle, rotation, and change in orientation of the sensing alarm unit mounted to the flagpole during movement from the generally horizontal position towards or too the generally vertical fish strike indicating position during a fish strike.

41. The alarm system of claim 40, wherein the sensor comprises at least one of a PMD sensor, a PIR sensor, an ultrasonic motion sensor, an ultrasonic distance sensor, an ultrasonic radar sensor, and a doppler sensor.

42. The alarm system of claim 40, wherein the sensor comprises at least one of a tilt sensor, an inclinometer, a gyro, an angular rate sensor, a magnetometer, an IMU sensor, a HRU sensor, and a GPS sensor.

43. The alarm system of claim 14,
(a) wherein the fishing apparatus comprises an ice fishing tip up having a base, a rotary drive shaft operatively connected to the base, a reel or spool carrying fishing line operatively connected to drive shaft at or adjacent one end thereof and rotating the drive shaft when a fish strikes, a crossbar operatively connected to the drive shaft at or adjacent an opposite end thereof and being displaced by rotation of the drive shaft by a fish strike, and a flagpole that releasably engages with the crossbar to releasably retain the flagpole in an armed position and which is displaced towards or to a fish strike indicating position when the crossbar disengages from the flagpole by rotation of the drive shaft by a fish strike;
(b) further comprising a magnet mounted to one of the (i) base and (ii) one of the crossbar and drive shaft of the ice fishing tip up; and
(c) wherein (i) the sensor of the sensing alarm unit comprises a magnet sensor, (ii) the sensing alarm unit comprises a first mount configured for mounting the sensing alarm to the base of the ice fishing tip up when the magnet is mounted to one of the cross bar and the drive shaft, the sensing alarm unit configured to dispose the magnet sensor in close enough proximity to sense the magnet mounted to the one of the crossbar and drive shaft of the ice fishing tip up; and (iii) the sensing alarm unit comprises a second mount configured for mounting the sensing alarm to the flagpole of the ice fishing tip up for movement substantially in unison therewith when the magnet is mounted to the base of the ice fishing tip up, the sensing alarm unit configured to dispose the magnet sensor in close enough proximity to sense the magnet mounted to the base of the ice fishing tip up when the flagpole is releasably engaged with the crossbar the armed position.

44. The alarm system of claim 43, wherein the sensing alarm unit comprises a second sensor, the second sensor configured to sense one of displacement, translation, change in angle, rotation, and change in orientation of the sensing alarm unit relative to part of the ice fishing tip up.

45. The alarm system of claim 44, wherein the sensing alarm unit comprises a second sensor, the second sensor comprising one of a motion sensor, a position sensor, an angle sensor, a tilt sensor, a proximity sensor, a distance sensor, a radar sensor, an acceleration sensor, and a velocity sensor.

46. The alarm system of claim 43, wherein the second mount comprises a clamp for releasably attaching the sensing alarm unit to the flagpole for movement substantially in unison therewith.

47. The alarm system of claim 46, wherein the first mount comprises one of a dovetail joint and a twist-lock joint.

48. The alarm system of claim 47, wherein the sensing alarm unit comprises a housing and a mounting base, the one of the dovetail joint and the twist-lock joint configured for releasable attachment of the base mount to the housing.

49. The alarm system of claim 48, wherein the mounting base is configured for being immovably fixed to the base of the ice fishing tip up, and the one of the dovetail joint and the twist-lock joint comprises a twist-lock rotary dovetail joint.

50. The alarm system of claim 49, wherein the wherein the clamp comprises a pair of outwardly extending clamp jaws or clamp fingers integrally formed of part of the mounting base.
